(19) United States
(12) Patent Application Publication
(10) Pub. No.: US 2022/0414538 A1
(43) Pub. Date: Dec. 29, 2022

(54) DETERMINING DYNAMIC INTERACTION CONDITION(S) FOR TRIGGERING PROVISION OF RELATED CONTENT INTERFACE NOTIFICATION

(71) Applicant: GOOGLE LLC, Mountain View, CA (US)

(72) Inventors: Ibrahim Badr, Zurich (CH); Sha Hossain, Mountain View, CA (US); Radwa Metwali, Mountain View, CA (US); Yun Zhou, Mountain View, CA (US); Praynaa Rawlani, Mountain View, CA (US)

(21) Appl. No.: 17/779,005

(22) PCT Filed: Dec. 13, 2019
(86) PCT No.: PCT/US2019/066199

§ 371 Date: May 23, 2022

(51) Int. Cl. G06N 20/00

(52) U.S. Cl. CPC G06N 20/00

(57) ABSTRACT

Implementations determine attribute(s) for an Internet resource; process the attribute(s) to generate predicted output; determine, based on the predicted output, interaction condition(s) for triggering provision of a related content interface notification for the Internet resource; and responsive to access of the Internet resource by a given client device, and responsive to determining the interaction condition(s): cause the given client device to render the related content interface notification in response to determining that the access of the Internet resource satisfies the interaction condition(s). In some implementations, the interaction condition(s) vary from Internet resource to Internet resource and/or can vary for a single Internet resource (e.g., based on a navigation path used in accessing the Internet resource and/or the client device used in accessing the Internet resource).

### BACKGROUND

Related content interface notifications have been proposed that are selectable during access of a given webpage and, when selected, present snippets of related Internet resource(s). For example, when viewing a webpage about the Kentucky Derby, a related interface notification can be selected and, when selected, snippets and links of webpages presented, where the webpages are determined to be related to the webpage about the Kentucky Derby. For example, the related webpages can include a webpage related to a Kentucky bourbon tour, a webpage related to the Preakness Stakes, etc. Two webpages (or other Internet resources) can be determined as related using various techniques, such as many users visiting both of the webpages (optionally in close temporal proximity), overlap in content (e.g., topics of the webpages), both webpages co-occurring frequently in search results, and/or other techniques.

However, current related content interface notifications are often rendered in a static manner. For example, they may be rendered as soon as the underlying webpage is accessed, or after certain fixed conditions are satisfied, such as scrolling through a fixed percentage of the webpage. The static rendering of a related content interface notification in a static manner can result in notifications being rendered too soon or too late (or not at all) during access of the underlying webpage. When rendered too soon, the related content interface notification can occupy often limited screen real estate and/or cause a user to temporarily divert from viewing the webpage, both of which can prolong the amount of time it takes for the user to view relevant portions of the webpage—leading to increased usage of client device resources in rendering the webpage. When rendered too late or not at all, a user can ignore or not even be presented with the notification and, instead, seek related content through more computer resource and/or network intensive means (e.g., performing Internet searching).

### SUMMARY

Implementations disclosed herein are related to determining dynamic interaction condition(s) for triggering provision of related content interface notifications for Internet resources (e.g., webpages, images, videos, portable document format (PDF) documents, state(s) and/or document(s) of an application, etc.). The interaction condition(s) are dynamic in that they can vary from Internet resource to Internet resource and/or can even vary for a single Internet resource. For example, they can vary for a single Internet resource in dependence on the navigation path taken in accessing the Internet resource and/or in dependence of a client device utilized in accessing the Internet resource and/or a user account associated with a user accessing the Internet resource. The interaction condition(s) for a given Internet resource can include, for example, a duration of access of the given Internet resource (e.g., elapsed time since the given Internet resource was requested, retrieved, or rendered) and/or scrolling condition(s) (e.g., whether scrolling has occurred, an extent of the scrolling, a speed of the scrolling, and/or a direction of the scrolling).

As one example, for a first webpage interaction conditions can include a fifteen second duration of access or scrolling through a certain percentage of the first webpage, and for a second webpage interaction conditions can include a ten second duration of access or scrolling through a different certain percentage of the second webpage. As another example, for a third webpage and for access of the third webpage via a first navigation path, interaction conditions can include a twenty second duration of access, and for the third webpage and for access of the third webpage via a second navigation path interaction conditions can include a fifteen second duration of access. It is noted that, when multiple interaction conditions are determined for a given resource, satisfaction of the conditions (which will result in provisioning of a related content interface notification) can be determined when any one of the interaction conditions is satisfied or, alternatively, when a combination of one or more (e.g., all) of the interaction conditions is satisfied.

Various implementations of determining dynamic interaction conditions can mitigate occurrences of late arriving and/or early arriving provisioning of related content interface notifications, thereby mitigating technical drawbacks of late and/or early arrival. Such mitigations can be especially impactful when considered across a large quantity of interactions of a population of users. Moreover, as described herein, various implementations determine the dynamic interaction conditions using a machine learning model trained based on interactions (or lack thereof) of users with previously provided related content interface notifications, ensuring technical drawbacks of late and/or early arrival are mitigated at least in aggregate across a population of users.

Some implementations disclosed herein are additionally or alternatively related to determining, for a given Internet resource, whether to even generate and/or provision any related content interface notification. Like the interaction condition(s), whether it is determined to provide a related interface notification can vary from Internet resource to Internet resource and/or can even vary for a single Internet resource. For example, determining whether to provide a related interface notification for an Internet resources can vary in dependence on the navigation path in accessing the Internet resource and/or in dependence of a client device utilized in accessing the Internet resource and/or a user account associated with a user accessing the Internet resource. Various implementations of determining whether to provision any related content interface notification can prevent waste of network and/or client device resources when a related content interface notification is not relevant, while ensuring a related content interface notification is rendered when relevant (thereby enabling more efficient access of corresponding related content). In some implementations that determine whether to even provision any related content interface notification, the determination is made using a machine learning model trained based on interactions (or lack thereof) of users with previously provided related content interface notifications, ensuring a distinction between relevant and non-relevant is meaningful at least in aggregate across a population of users. In some of those implementations, the same machine learning model can be used in determining whether to provide any related content interface notification and in determining interaction condition(s) for any provisioning of the related content interface notification.

Various implementations of determining whether to generate any related content interface notification for an Internet resource can also prevent waste of network and/or server resources utilized in determining related resource(s) that are related to the Internet resource. For example, related resource(s) can be determined based on: performing Internet search(es) based on the content of the Internet resource and identifying related resource(s) from search results for those search(es); analyzing historical data to determine related resource(s) visited in close temporal proximity to the Internet resource; analyzing database(s) to determine related resource(s) that share topic(s) in common with the Internet resource and/or that are responsive to the same or similar queries as is the Internet resource; and/or performing other network and/or server resource intensive techniques. Accordingly, resources can be conserved by only performing these network and/or server resource intensive technique(s) when, for example, it is determined that a related interface notification should be provided. As mentioned above, the determination of whether to provide a related interface notification can be made using a machine learning model trained based on interactions (or lack thereof) of users with previously provided related content interface notifications, and can optionally be the same machine learning model used in determining interaction condition(s) for any provisioning of the related content interface notification.

Some implementations disclosed herein are additionally or alternatively related to determining whether to pre-cache (and/or an extent of the pre-caching), at a client device viewing an Internet resource, related content resource(s) that are linked-to in a related content interface notification. Pre-caching a related content resource can reduce latency in rendering the related content resource if a corresponding link is selected in the related content interface notification. For example, a related content interface notification can include, as a top-most presented related content item, a snippet of content from a corresponding additional webpage. At least some (e.g., all) of the corresponding additional webpage can be pre-cached at the client device, while viewing the Internet resource, based on determining to pre-cache related content item(s). In some of those implementations, whether to pre-cache related content item(s), and/or the extent of the pre-caching, for an Internet resource can be based on the determined interaction condition(s) for the Internet resource. For example, it can be determined to not pre-cache when the determined interaction condition(s) for the Internet resource include a greater than 30 second duration, to pre-cache to a first extent when the interaction conditions include a 15-30 second duration, and to pre-cache to a greater extent (e.g., more related content item(s) and/or a greater extent of related content item(s)) when the interaction conditions include a less than 15 second duration. Accordingly, implementations disclosed herein, when it is determined to provide a related interface notification for an Internet resource, determine whether and/or an extent of pre-caching of content item(s) linked-to in the related interface notification. Those implementations seek to mitigate latency in rendering related content item(s) through pre-caching of the related content item(s), but also seek to balance the latency reduction with network usage concerns through only selectively pre-caching (e.g., only for certain Internet resources and/or navigational paths) and/or pre-caching to a dynamic extent.

Various attributes can be utilized in determining interaction condition(s) and/or in determining whether to generated and/or provision a related content interface notification for a given Internet resource. Those attributes include, for example, content attribute(s), navigation attribute(s), global historical attribute(s), personal historical attribute(s), and/or related content attribute(s).

The content attribute(s) for a given Internet resource are based on content of the given Internet resource. The content attribute(s) can include, for example, type attribute(s) that indicate type(s)/verticals, of a plurality of disparate types, to which the given Internet resource conforms. The disparate types can be defined with various levels of granularity and can include, for example, news (and/or more granular types such as technology news, politics news, etc.), travel (and/or more granular types such as air travel, car travel, Western US travel, etc.), shopping (and/or more granular types such as home goods shopping, electronics shopping), and/or other types. The given Internet resource can be determined to be of only a single type, or can be determined to be of multiple types (optionally with weightings for each). In various implementations, a trained classifier is utilized to process content of the given Internet resource (e.g., a word embedding of a title and/or certain sentence(s)), and to generate predicted output that predict(s) the type(s) of the given Internet resource. The content attribute(s) can additionally or alternatively include one or more lower-dimensional embeddings of at least some of the content of the given Internet resource, such as a word embedding (e.g., using Word2Vec or other technique) of term(s) of the given Internet resource. The content attribute(s) can additionally or alternatively include one or more structural attributes of at least some of the content of the given Internet resource. The structural attributes can be based on which markup language (e.g., XML tags or HTML tags) are included in the given Internet resource and/or an organizational structure (e.g., order) of the markup language.

The navigation attribute(s) for a given Internet resource indicate one or more particular attributes for navigating to the Internet resource. As a result, when navigation attribute(s) are used in determining whether to provide a related content interface notification and/or interaction condition(s) for its provisioning, the determination(s) are specific to the navigation attribute(s) and are used only for access of the given Internet resource as a result of navigation that conforms to the navigation attribute(s). In some implementations, the navigation attribute(s) include a path attribute that indicates which navigation path, of a plurality of navigational paths, was utilized for accessing the Internet resource. Various navigational paths of various granularities can be utilized. For example, the navigational paths can include a query-based path (e.g., a link to the given Internet resource was presented as a search result responsive to a query, and selected) and a query-independent path (e.g., selecting a link to the given Internet resource that is provided in a proactive “content feed”, or navigating to the given Internet resource by typing its URL in the address bar). As another example, the navigation paths can include more granular query-based paths, such as multiple query-based paths corresponding to different breadths of queries.

For instance, assume a webpage for Hypothetical Café, a hypothetical restaurant in Louisville, Ky. that serves vegan cuisine. A query of “Hypothetical Café Louisville, Ky.” can be classified as a first breadth (e.g., a very narrow or navigational) query for the webpage, a query of “Vegan Cuisine Louisville Ky.” can be classified as a broader second breadth for the webpage, and a query of “Restaurants Louisville Ky.” can be classified as an even broader breadth for the webpage. Generally, when a given Internet resource is accessed as a result of a broader query, a related content interface notification is more likely to be provided and/or will be provided with “more aggressive” interaction condition(s) than if the given Internet resource is accessed as a result of a more narrow query (e.g., a navigational query). This can be a factor of the navigational or more narrow queries indicating a desire to view a certain (or limited set) of Internet resources, while the broader queries indicate a desire to explore multiple Internet resources related to certain topic(s).

The global historical interaction attribute(s) for a given Internet resource indicate measured past extents of past interactions, with previous related content interface notifications, responsive to previous renderings of the previous related content interface notifications for past accesses, by a plurality of client devices, of the given Internet resource and/or of additional Internet resources determined to be similar to the given Internet resource. Additional Internet resources can be determined to be similar to the given Internet resource utilizing various techniques such as comparing a word (and/or other content) embedding for content of the given Internet resource to the additional Internet resource(s) and determining they are similar if the embeddings satisfy a distance threshold.

The personal historical interaction attribute(s) for a given Internet resource indicate measured past extents of past interactions, by a user of a given client device, with previous related content interface notifications (e.g., all previous related content interface notifications, recent ones, and/or for those on Internet resource(s) determined to be similar to the given Internet resource). As a result, the personal historical interaction attribute(s) are personal to the current access of the given Internet resource, and when personal historical interaction attribute(s) are used in determining whether to provide a related content interface notification and/or interaction condition(s) for its provisioning, the determination(s) are specific to the current access.

The related content attribute(s) are based on one or more related Internet resources that are linked-to in the related content notification for the Internet resource, or that are rendered in response to selection of the related content notification. For example, the related content attribute(s) can be based on determined query-independent measure(s) for one or more of the related Internet resource(s). The query-independent measure(s) of an Internet resource can be based on, for example, frequency of access of the Internet resource, in-bound link(s) to the Internet resource, and/or other query-independent properties of the Internet resource. The related content attribute(s) for a related Internet resource can additionally or alternatively be based on a strength of relationship between the related Internet resource and the given Internet resource. The strength of relationship between the related Internet resource and the given Internet resource can be based on, for example, how many users visit both of the Internet resources (optionally in close temporal proximity), an extent of overlap in content of the Internet resources (e.g., topics of the Internet resources), and/or how frequently both Internet resources co-occur in search results.

The above description is provided as an overview of only some implementations disclosed herein. Those implementations, and other implementations, are described in additional detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

FIG. 1 depicts a block diagram of an example environment that demonstrates various aspects of the present disclosure, and in which implementations disclosed herein may be implemented.

FIGS. 2A and 2B each depict some components of FIG. 1, and example interactions that can occur between the components, in accordance with various implementations.

FIG. 3 depicts a flowchart illustrating an example method of training a machine learning model, in accordance with various implementations.

FIG. 4 depicts a flowchart illustrating an example method of determining whether and/or when to render a related content interface notification, in accordance with various implementations.

FIGS. 5A, 5B, 5C, and 5D depict various non-limiting examples of related content interface notifications, in accordance with various implementations.

FIG. 6 depicts an example architecture of a computing device, in accordance with various implementations.

### DETAILED DESCRIPTION

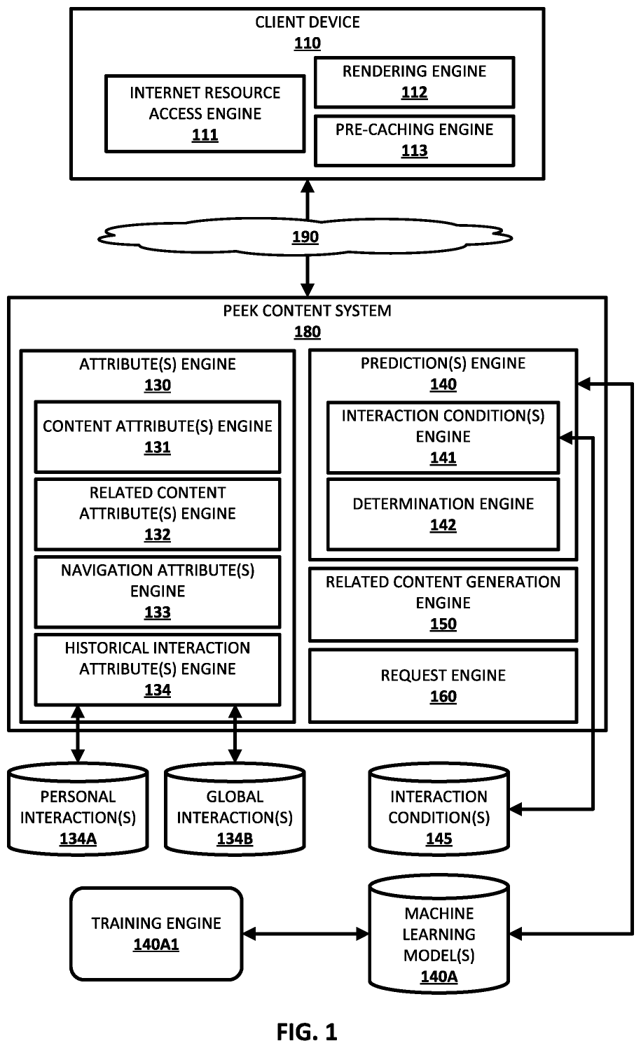

FIG. 1 illustrates a block diagram of an example environment that demonstrates various aspects of the present disclosure. A client device 110 is illustrated in FIG. 1, and includes Internet access resource engine 111, rendering engine 112, and pre-caching engine 113.

The Internet resource access engine 111 can detect access of a given Internet resource at the client device 110. The access of the given Internet resource can be via one or more user interactions with a web browser or other software application(s) installed on the client device 110. As one non-limiting example, Internet resource engine 111 can be integrated as part of a web browser installed on the client device 110 and can detect an Internet resource accessed via the web browser. As another non-limiting example, Internet resource engine 111 can be part of an operating system or an assistant application of the client device 110, and can detect an Internet resource accessed via a web browser application, a social media application, or other application.

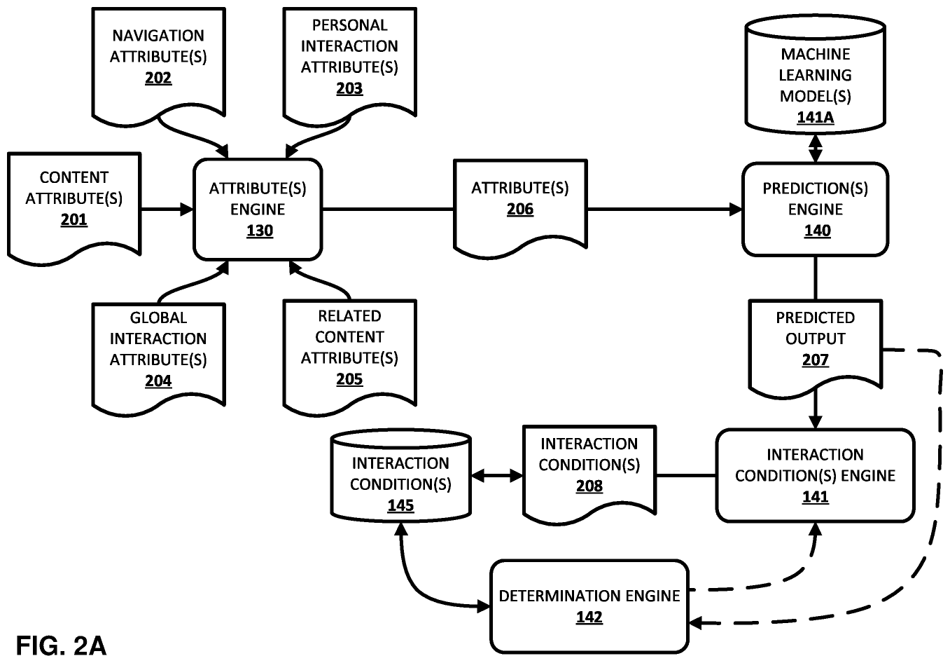

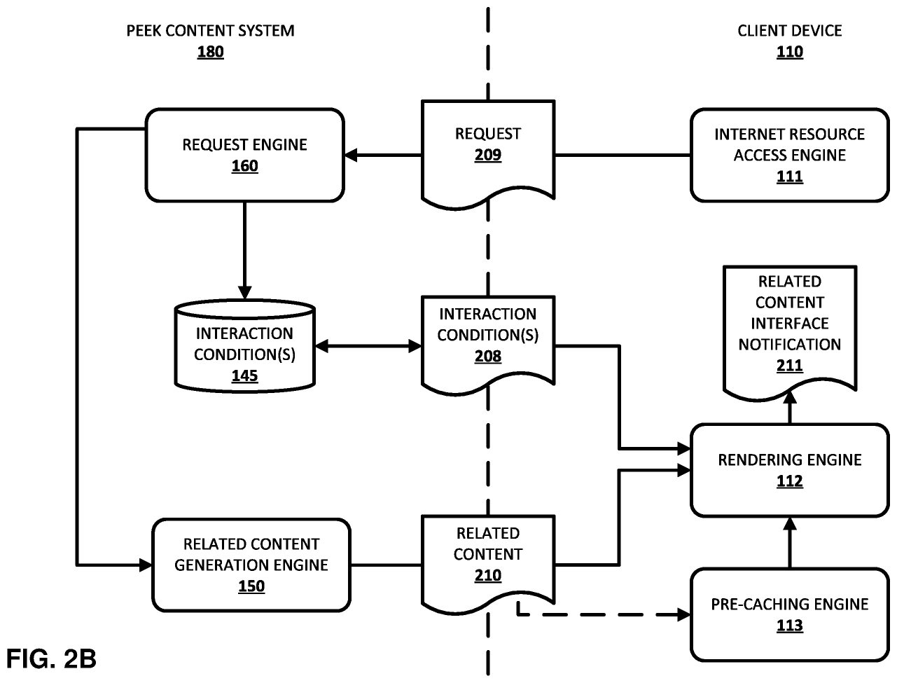

In response to access of a given Internet resource, the Internet resource engine 111 can transmit, to a peek content system 180 and over one or more networks 190 (e.g., Wi-Fi, Bluetooth, local area network(s), wide area network(s), and/or other networks), a request for one or more interaction conditions for provision of a related content interface notification for the accessed Internet resource (e.g., as described in more detail in FIG. 2B). The request can include, for example, a Uniform Resource Identifier (URI) of the Internet resource. The request can also include navigational path data indicating a navigational path for accessing the Internet resource. The navigational path data can be included in the URI (e.g., in a query component of the URI) and/or separate from the URI. The request can also optionally include an identifier of the client device 110 and/or of an account of the client device 110 (e.g., the account associated with the access of the Internet resource).

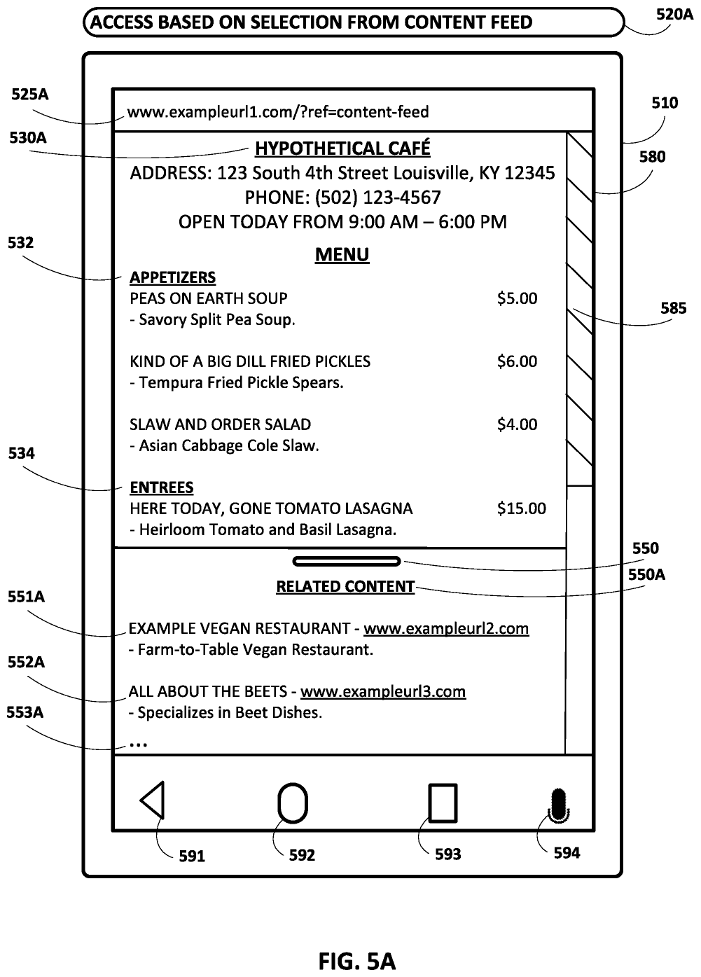

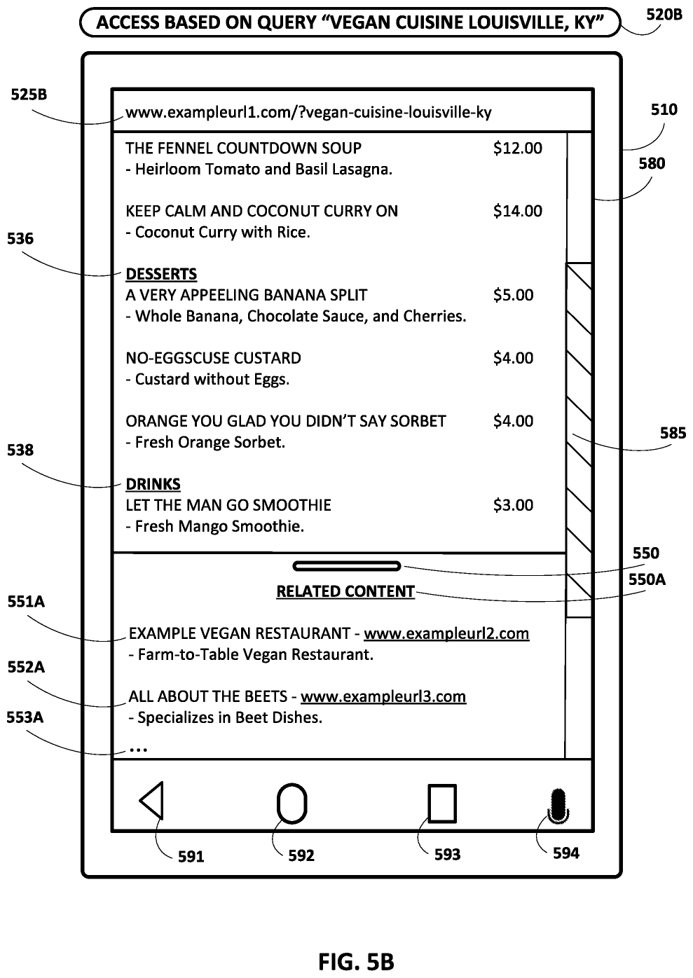

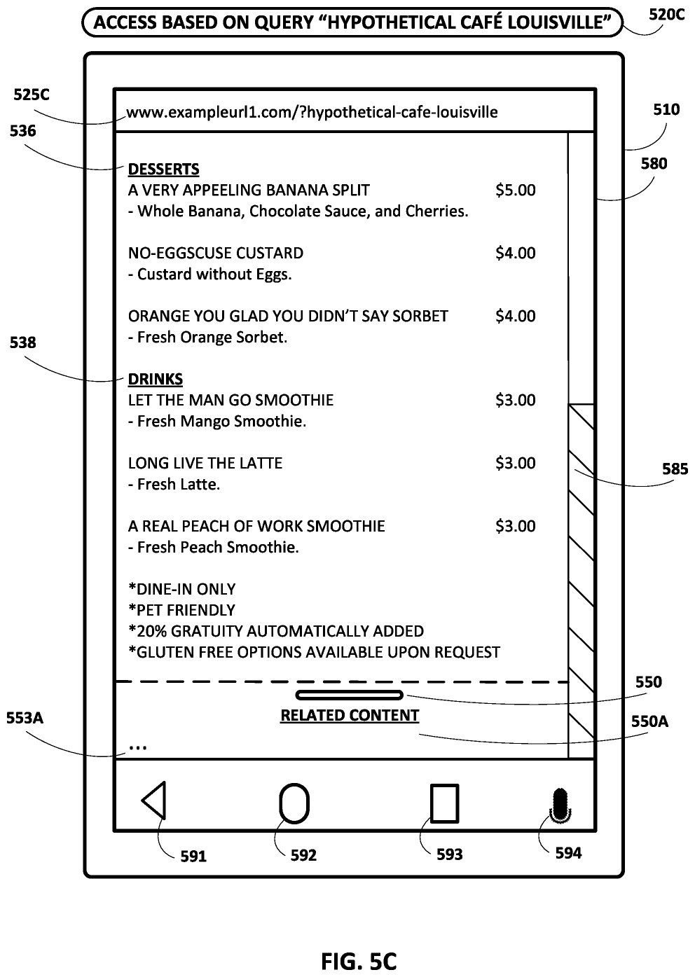

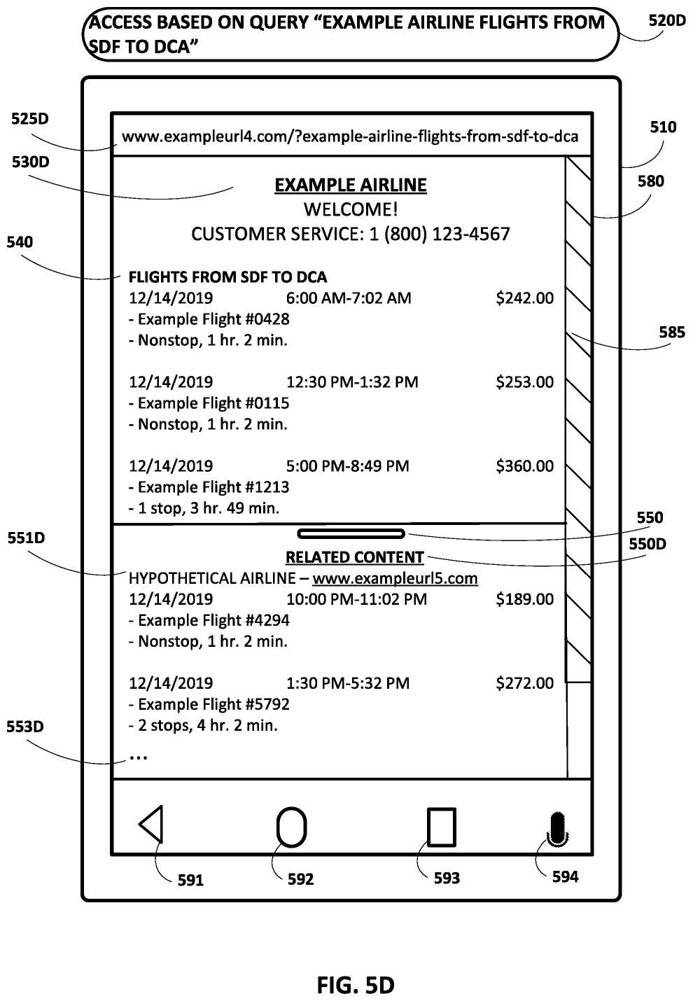

Responsive to transmitting the request, the client device 110 can receive, from the peek content system 180 and over one or more of the networks 190, one or more interaction conditions for a related content interface notification for the accessed Internet resource, and optionally, content for rendering in the related content interface notification. The content for rendering in the related content interface notification can include content for rendering upon initial presentation of the related content interface notification and/or after “expansion” of the related content interface notification (e.g., responsive to user interface input such as a tap, a swipe-up, a swipe-down, and/or other user interface input). The rendering engine 112 can monitor for occurrence of the interaction condition(s) and, responsive to detect satisfaction of the interaction condition(s), render the related content interface notification. The related content interface notification can include related content that is related to the accessed Internet resource. In some implementations, the related content can be pre-cached in one or more databases (not depicted) of the client device 110 and can be retrieved using pre-caching engine 113 for inclusion in the related content interface notification (e.g., as described in more detail in FIG. 2B). In some versions of those implementations, the pre-caching engine 113 can store underlying content of the related content (e.g., content of related Internet resources) in one or more of the databases. In other versions of those implementations, the pre-caching engine 113 only stores an indication of the related content, such as a snippet of the related Internet resources (e.g., as illustrated by 551A and 551B in FIGS. 5A and 5B), in one or more of the databases.

The peek content system 180 can, in some implementations, be implemented at least in part by one or more servers. The peek content system 180 can include attribute(s) engine 130, prediction(s) engine 140, related content generation engine 150, and request engine 160. The attribute(s) engine 130 can determine a plurality of attributes for a given Internet resource. The plurality of attributes can include, for example, content attribute(s) determined using content attribute(s) engine 131; related content attribute(s) determined using related content attribute(s) engine 132; navigation attribute(s) determined using navigation attribute(s) engine 133; personal and/or global historical interaction attribute(s) determined using historical interaction attribute(s) engine 134; and/or other attribute(s) determined using the attribute(s) engine 130.

The prediction(s) engine 140 can include an interaction condition(s) engine 141 and optionally a determination engine 142. The interaction condition(s) engine 141 can apply the plurality of attributes as input across machine learning model(s) 140A to generate predicted output. Based on the predicted output, the interaction condition(s) engine 141 can determine interaction condition(s) for a given Internet resource. Further, the determination engine 142 can determine whether the client device 110 should render a related content interface notification based on the interaction condition(s) and/or based on a separate portion of the predicted output (i.e., a different portion of the predicted output that that used to generate the interaction condition(s)). If the determination engine 142 determines that the related interface notification should be rendered for the Internet resource (at least for certain navigation paths and/or other condition(s)), the interaction condition(s) determined by interaction condition(s) engine 141 can be provided by the peek content system 180 to client device 110. When the interaction condition(s) are satisfied, the rendering engine 112 of the client device 110 can render the related content interface notification via a display of the client device 110. However, if the determination engine 142 determines that the client device 110 should not render the related content interface notification, then the peek content system 180 can, responsive to a request from Internet resource access engine 111 associated with the resource, provide a response that indicates no rendering of a related content interface notification should occur, or the peek content system 180 can refrain from providing any response.

In some implementations, when the determination engine 142 makes a determination based on predicted output that is separate from the predicted output utilized by interaction condition(s) engine 141, the interaction condition(s) engine 141 can optionally determine interaction condition(s) for a given resource only responsive to determination engine 142 determining that a related interface notification should be provided. Accordingly, computational resources can be conserved by refraining from determining the interaction condition(s) in situations in which the determination engine 142 determines a related content interface notification should not be provided for a corresponding Internet resource. As described herein, the interaction condition(s) determined by interaction condition(s) engine 141 are dynamic in that they can vary from Internet resource-to-Internet resource based on the plurality of attributes for the given Internet resource, and can vary for a given Internet resource based on a navigation path for accessing the given Internet resource.

The content attribute(s) engine 131 can determine, based on content of a given Internet resource, type attribute(s) that indicate type(s)/verticals, of a plurality of disparate types, to which the given Internet resource accessed at the client device 110 conforms (e.g., news, travel, shopping, restaurant, sports, and/or other types). The given Internet resource can be determined to be of only a single type, or can be determined to be of multiple types (optionally with weightings for each). For example, the Internet resource accessed at the client device can be a news type and sports type and assigned a weight of 0.6 for the news type and a weight of 0.4 for the sports type. In various implementations, the content attribute(s) engine 131 can also generate, using a trained classifier and based on content of the given Internet resource (e.g., a word embedding of a title and/or certain sentence(s)), output that predict(s) the type(s) of the given Internet resource.

In some additional and/or alternative implementations, the content attribute(s) engine 131 can generate one or more lower-dimensional embeddings of at least some of the content of the given Internet resource, such as a word embedding (e.g., using Word2Vec or other technique) of term(s) of the given Internet resource. For example, the content attribute(s) engine 131 can generate a word embedding, based on a heading, body, metadata, and/or other content of the given Internet resource, where the word embedding is in an embedding space. By mapping content of an Internet resource to an embedding space, similar Internet resources (e.g., different types) can be grouped together in the embedding space based on the underlying content of the Internet resources. Further, in some additional and/or alternative implementations, the content attribute(s) engine 131 can determine one or more structural attributes of at least some of the content of the given Internet resource. The structural attributes can be based on which markup language (e.g., XML tags or HTML tags) are included in the given Internet resource and/or an organizational structure (e.g., order) of the markup language. For example, assume an Internet resource is a webpage for an airline. In this example, the webpage for the airline will include structured information (e.g., flight dates/time, cost, flight number, and/or other information). Thus, by considering the content attribute(s) determined using the content attribute(s) engine 131, the interaction condition(s) can vary for each Internet resource that is accessed by the client device 110.

The related content attribute(s) engine 132 can determine one or more query-independent measures for related Internet resource based on related Internet resources that are linked-to in the related content notification for the Internet resource, or that are rendered in response to selection of the related content interface notification. As described in more detail herein, the related content attribute(s) engine 132 can leverage information processed by the related content engine 150. The query-independent measures for the related Internet resource can be based on, for example, frequency of access of the Internet resource, in-bound link(s) to the Internet resource, and/or other query-independent properties of the Internet resource. Further, in some additional and/or alternative implementations, the related content attribute(s) engine 132 can determine a strength of relationship between a given Internet resource and one or more related Internet resources. The strength of relationship between the given Internet resource and the one or more related Internet resources can be based on, for example, how many users visit both of the Internet resources (optionally in close temporal proximity), an extent of overlap in content of the Internet resources (e.g., topics of the Internet resources), and/or how frequently both Internet resources co-occur in search results.

In some versions of those additional and/or alternative implementations, the related content attribute(s) engine 132 may only consider the related content attribute(s) if the strength of relationship between the given Internet resource and one or more of the related Internet resources satisfies a threshold. For example, for a webpage for Example Airline, assume a webpage for Hypothetical Airline frequently co-occurs with search results for flight information along with Example Airline. Further assume that, responsive to receiving the search results for the flight information, most users generally view the webpage for Example Airline, and subsequently view the webpage for Hypothetical Airline. Based on both the co-occurrence of the webpage for Example Airline and the webpage for Hypothetical Airline and the access of both webpages, the related content attribute(s) engine 132 can determine a strong strength of relationship (e.g., 0.8) between the webpage for Example Airline and the webpage for Hypothetical Airline that satisfies the threshold (e.g., 0.7). Further, the strength of the relationship can be based on a temporal proximity between accessing the webpage for Example Airline and the webpage for Hypothetical Airline. For example, if most users access the webpage for Example Airline and immediately thereafter accesses the webpage for Hypothetical Airline, then the strength of relationship score can be stronger (e.g., 0.9) than if most users access one or more other webpages in the intermediate (e.g., 0.6). Thus, by considering the related content attribute(s) determined using the related content attribute(s) engine 132, the interaction condition(s) can vary for each Internet resource (e.g., as described in more detail herein with respect to FIG. 5D).

The navigation attribute(s) engine 133 can determine one or more particular navigation attribute(s) for navigating to a given Internet resource. In implementations when navigation attribute(s) are used in determining whether to provide a related content interface notification and/or interaction condition(s), the determinations (e.g., by determination engine 142 of FIG. 1) are specific to the navigation attribute(s) and are used only for access of the given Internet resource as a result of navigation that conforms to the navigation attribute(s). In some of those implementations, the navigation attribute(s) include a path attribute that indicates which navigation path, of a plurality of navigational paths, is utilized for accessing the Internet resource (e.g., as described in more detail herein with respect to FIGS. 5A-5D). The interaction condition(s) for a given Internet resource can be further based on the navigation path used to access the given Internet resource.

For example, the navigational paths can include both query-dependent path(s) (e.g., a link to the given Internet resource was presented as a search result responsive to a query, and selected) and a query-independent path (e.g., selecting a link to the given Internet resource that is provided in a proactive “content feed” of the client device 110, or navigating to the given Internet resource by typing its URL in an address bar). For the query-dependent path(s), the navigation paths can include multiple query-dependent paths corresponding to, for example, different breadths of queries (e.g., as described in more detail herein with respect to FIGS. 5B and 5C). For example, if a given Internet resource is accessed by a navigation path corresponding to a proactive content feed of the client device 110 or a broader query, then the interaction conditions can be “more aggressive” than if the given Internet resource is accessed by a navigation path corresponding to a more narrow query (e.g., a navigational query).

In other words, if a given Internet resource is accessed by a navigation path that indicates a user of the client device 110 is generally browsing Internet resources (e.g., using a content feed and/or a broad query for restaurants generally), then the interaction conditions can indicate it is more likely the user will interact with a related content interface notification, and the related content interface notification can be quickly provided to such that the user does not need to return to the content feed or search results page, thereby reducing user input at the client device 110. In contrast, if a given Internet resource is accessed by a navigation path that indicates a user of the client device 110 is looking for a specific Internet resource (e.g., using a navigational query for a particular restaurant), then the determined interaction conditions can indicate it is less likely the user will interact with a related content interface notification since the user is looking for a specific Internet resource, and the related content interface notification can be withheld for some time (if provided at all). Accordingly, computational resources of the client device 110 can be conserved by delaying (or eliminating altogether) rendering of the related content interface notification at the client device 110, and network resources can be conserved by providing the related content interface notification at the right time, if at all. Moreover, it should be noted that when considering this conservation of resources for a large population of users, a substantial amount of network resources can be conserved.

The historical interaction attribute(s) engine 134 can determine personal historical interaction attribute(s) and/or global historical interaction attribute(s) for a given Internet resource. The historical interaction attribute(s) engine 134 can determine personal historical interaction attribute(s) for a given Internet resource based on measured past extents of past interactions, by a given user of the client device 110, with previous related content interface notifications (e.g., all previous related content interface notifications, recent ones, and/or for those on Internet resource(s) determined to be similar to the given Internet resource). The historical interaction attribute(s) engine 134 can retrieve, from personal interaction(s) database 134A, personal past interaction(s) with a plurality of Internet resources and/or past interaction(s) with related content interface notifications rendered while the user viewed each of the plurality of Internet resources.

The personal interaction(s) database 134A can include, for example, data that indicates the user of the client device 110 previously accessed a plurality of Internet resources, and information about the previous access of each of the plurality of Internet resources. For example, the personal interaction(s) database 134A can include interaction conditions (e.g., duration of access and/or scrolling conditions) encountered for prior access of a plurality of Internet resources for the given user. As described herein, additional Internet resources can be determined to be similar to the given Internet resource utilizing various techniques such as comparing a word (and/or other content) embedding for content of the given Internet resource to the additional Internet resource(s) and determining they are similar if the embeddings satisfy a distance threshold. Thus, the personal historical interaction attribute(s) determined using the historical interaction attribute(s) engine 134 are personal to the user accessing the given Internet resource on the client device 110 (e.g., as described herein with respect to FIG. 5A).

Further, the historical interaction attribute(s) engine 134 can determine global historical interaction attribute(s) for a given Internet resource based on measured past extents of past interactions, by a plurality of additional users (i.e., that are in addition to the user of the client device 110), with previous related content interface notifications for the given Internet resource. These past interactions of the plurality of additional users can be retrieved from a global interaction(s) database 134B. For example, the global interaction(s) database 134B can include interaction conditions (e.g., duration of access and/or scrolling conditions) encountered for prior access of a given Internet resource for the plurality of additional users. Further, if a related content interface notification was rendered during the prior access, the global interaction(s) database 134B can include an indication of whether each of the plurality of user interacted with the related content interface notification, and, if so, an extent of the interaction (e.g., accessed underlying content of the related content interface notification, viewed additional related content of the related content interface notification, dismissed the related content interface notification, and/or other historical interactions).

The global interaction(s) database 134B can include, for example, data that indicates the plurality of additional users previously accessed a given Internet resource, and information about the previous access of each of the plurality of additional users. Thus, the global historical interaction attribute(s) determined using the historical interaction attribute(s) engine 134 for the given Internet resource can be generalized based on interactions of other users with the given Internet resource and/or similar Internet resources (e.g., as described herein with respect to FIG. 5A).

As noted above, the prediction(s) engine 140 can include at least interaction condition(s) engine 141 and determination engine 142. The prediction(s) engine 140 can apply the plurality of attributes determined by the attribute(s) engine 130 as input across machine learning model(s) 140A to generate predicted output. Further, the interaction condition(s) engine 141 can determine interaction condition(s) for a given Internet resource based on the predicted output, and the determination engine 142 can also determine whether the client device 110 should render a related content interface notification based on the predicted output. If the determination engine 142 determines that the client device 110 should render the related content interface notification, the client device 100 can, when the interaction conditions(s) are satisfied, transmit a single to the client device 110 to cause the rendering engine 112 to render the related content interface notification via a user interface of the client device 110.

The interaction condition(s) for a given Internet resource can include, for example, a duration of access of the given Internet resource (e.g., elapsed time since the given Internet resource was requested, retrieved, or rendered), scrolling condition(s) (e.g., whether scrolling has occurred, an extent of the scrolling, a speed of the scrolling, and/or a direction of the scrolling). Further, the interaction condition(s) can depend on a navigation path utilized to access the given Internet resource. As one example, for a first webpage, interaction condition(s) can include a fifteen second duration of access and/or scrolling through a certain percentage of the first webpage, and, for a second webpage, interaction condition(s) can include a ten second duration of access and/or scrolling through a different certain percentage of the second webpage. As another example, for a third webpage, and for access of the third webpage via a first navigation path (e.g., query-dependent navigation path), interaction conditions can include a twenty second duration of access, and, for the third webpage and for access of the third webpage via a second navigation path (e.g., query-independent navigation path), interaction conditions can include a fifteen second duration of access. It is noted that, when multiple interaction conditions are determined for a given resource, satisfaction of the conditions (which will result in provisioning of a related content interface notification) can be determined when any one of the interaction conditions is satisfied or, alternatively, when a combination of one or more (e.g., all) of the interaction conditions is satisfied. Thus, the interaction condition(s) are dynamic in that they can vary from Internet resource-to-Internet resource and/or can even vary for a single Internet resource (e.g., in dependence on the navigation path in accessing the Internet resource and/or the client device and/or user account accessing the Internet resource).

Moreover, by utilizing dynamic interaction conditions, the peek content system 180 can mitigate occurrences of late arriving and/or early arriving provisioning of related content interface notifications, thereby mitigating technical drawbacks of late and/or early arrival. Further, as described herein, various implementations determine the dynamic interaction conditions using a machine learning model trained based on interactions (or lack thereof) of users with previously provided related content interface notifications, ensuring technical drawbacks of late and/or early arrival are mitigated at least in aggregate across a population of users.

The machine learning model(s) 140A utilized by the prediction(s) engine 140 can be trained using training engine 140A1. The training engine 140A1 can utilize one or more training techniques in training the machine learning model(s) 140A. The machine learning model(s) 140A can include, for example, neural network model(s), support vector machine(s), Bayesian network(s), and/or other machine learning model(s). In some implementations, the training engine 140A1 can utilize reinforcement learning techniques for training the machine learning model(s) 140A. In some other implementations, the training engine 140A1 can utilize supervised learning techniques for training the machine learning model(s) 140A.

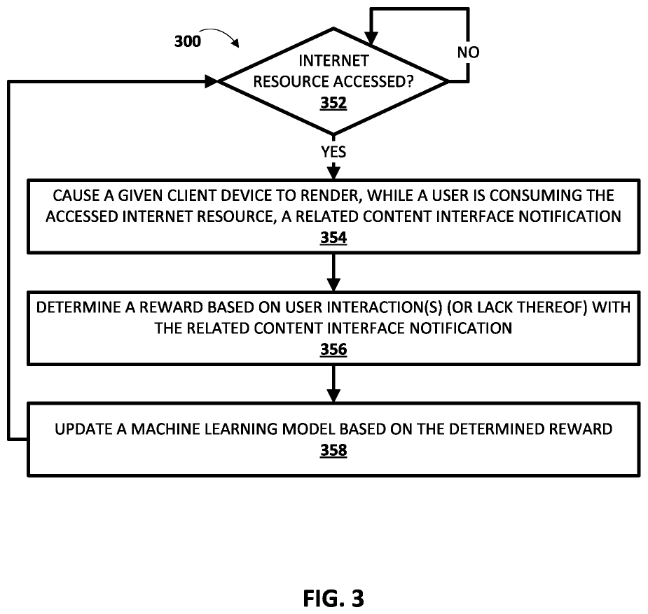

In implementations that utilize reinforcement learning training techniques, a related content interface notification can be rendered while a user is consuming a given Internet resource. For a given state-action space of the client device, discrete actions can be sampled to determine interaction conditions for provision of the related content interface notification. In some implementations, the training can be performed “online” (e.g., as described below), while in some additional and/or alternative implementations, the training can be performed “offline” to bootstrap the machine learning model(s) 140A (e.g., as described in more detail herein with respect to FIG. 3). For example, for a given state (e.g., s₁), the training engine 140A1 can sample a plurality of discrete actions (e.g., a₁, a₂, . . . , a_{N}, where N is a positive integer). The state can correspond to, for example, the plurality of attribute(s), and each of the discrete actions can correspond to, for example, a duration of access of the given Internet resource and/or scrolling condition(s) for the given Internet resource. Further, a probability, for each of the actions and for the given state, can be determined based on predicted output of the machine learning model(s) 140A. For example, a first discrete action can include a duration of access of ten seconds for the given Internet resource and scrolling condition(s) that the user scroll through 20% of the given Internet resource; a second discrete action can include a duration of access of twenty seconds for the given Internet resource, but no scrolling conditions; and so on.

In some implementations, a given one of the discrete actions can be selected based on the probabilities, for each of the actions for the given state, and other discrete actions, similar to the selected action, can be re-sampled. For example, a selected discrete action can include a duration of access of ten seconds for the given Internet resource and scrolling condition(s) that the user scroll through 20% of the given Internet resource; a second discrete action can include a duration of access of ten seconds for the given Internet resource and scrolling condition(s) that the user scroll through 25% of the given Internet resource; a third discrete action can include a duration of access of twelve seconds for the given Internet resource and scrolling condition(s) that the user scroll through 20% of the given Internet resource; and so on. Thus, a set of discrete actions can be analyzed, and a given discrete action (e.g., interaction condition(s) for the given Internet resource) can be selected based on corresponding probabilities for each discrete action, in the set of discrete actions.

Moreover, based on the selected discrete action, a given client device can render a related content interface notification when the interaction conditions(s) indicated by the given discrete action. Further, a reward can be determined, based on one or more user interaction(s) (or lack thereof) with the related content interface notification, when the interaction conditions(s) indicated by the given discrete action are satisfied (e.g., as described in FIG. 3). For example, one or more weights of the machine learning model(s) 140A for determining the probability associated with the given discrete action can be updated. In this manner, the machine learning model(s) 140A can be updated for each of the discrete actions in the discrete action space based on a plurality of user interaction(s) of a plurality of users (optionally including or excluding the user of the client device 110).

In implementations that utilize supervised learning training techniques, and similar to utilizing a reinforcement learning technique, a related content interface notification can be rendered while a user is consuming a given Internet resource. However, rather than sampling actions (e.g., interaction condition(s)) from a discrete action space for a given state (e.g., attribute(s) for a given Internet resource) as with reinforcement learning, a plurality of attributes of the given Internet resource can be applied as input across the machine learning model(s) to generate predicted output. Further, the related content interface notification can be rendered, via a user interface of a client device, upon access of a given Internet resource, or shortly thereafter. Based on one or more user interactions (or lack thereof) with the related content interface notification, ground truth output corresponding to the predicted output for the related content interface notification can be generated. Moreover, the ground truth output can be compared to the predicted output to determine an error, and the error can be backpropagated across the machine learning model(s) 140A (e.g., using one or more backpropagation techniques), thereby updating the machine learning model(s) 140A based on the error.

For example, assume a related content interface notification is rendered along with a webpage, and a user views the webpage for thirty seconds and scrolls through 40% of the webpage prior to interaction with the related content interface notification. Further assume that a predicted output is generated based on a plurality of attribute(s) of the webpage, and that interaction condition(s), generated based on the predicted output, include a duration of access of fifty seconds and/or a scrolling condition of 60%. In this example, the ground truth output can be generated based on the user viewing the webpage for thirty second and scrolling through 40% of the webpage. However, the predicted output generated based on the plurality of attribute(s) of the webpage resulted in interaction condition(s) of a duration of access of fifty seconds and/or a scrolling condition of 60%. Accordingly, the ground truth output based on the actual interaction with the related content interface notification for the webpage can be compared to the predicted output to generate the error, and the error can be backpropagated across the machine learning model(s) 140A. This technique can be iteratively performed for a plurality of Internet resources, and based on interactions of a plurality of users. Moreover, each iteration can focus on a single one of the interaction condition(s) and/or each of the interaction condition(s). In this manner, for a given Internet resource, the machine learning model(s) 140A can be iteratively updated using supervised learning techniques.

Further, the determination engine 142 can also utilize the predicted output from machine learning model(s) to determine whether the related content interface notification should be provided to a user of the client device 110 and/or whether the interaction condition(s) should be stored in interaction condition(s) database 145. For example, FIG. 2A depicts some components of FIG. 1, and example interactions that can occur between the components, in accordance with various implementations. The attribute(s) engine 130 can determine a plurality of attribute(s) 206, including content attribute(s) 201, navigation attribute(s) 202, personal interaction attribute(s), global interaction attribute(s) 204, and/or related content attribute(s) 205. The prediction(s) engine 140 can process the attribute(s) 206, using the machine learning model(s) 140A, to generate predicted output 207.

In some implementations, the interaction condition(s) engine 141 can determine interaction conditions(s) 208, and the interaction condition(s) 208 can be stored in the interaction condition(s) database 145. In some versions of those implementations, the interaction condition(s) 208 are indexed by Internet resource, and, optionally, by each navigational path for each Internet of the Internet resources. For example, the interaction condition(s) 208 for a given Internet resource can be stored in the interaction condition(s) database 145 as a URI and/or URL for the given Internet resource. Further, different interaction condition(s), specific to each navigation path for accessing the given Internet resource, can be stored in association with the URI and/or URL for the given Internet resource. By indexing the interaction condition(s) 208 in the interaction condition(s) database 145 based on the URI and/or URL, and, optionally, by the different navigation paths for accessing the given Internet resource, the interaction condition(s) 208 can be quickly identified responsive to the request 209, thereby mitigating latency in responding to the request 209. This enables the interaction condition(s) 208 to be determined once for a given Internet resource, but used for multiple requests, thereby preventing computationally intensive redetermination of the interaction condition(s) 208 for each request (although the interaction condition(s) 208 can be updated responsive to change in content of Internet resource and/or updated versions of the machine learning model(s) 140A).

In some versions of those implementations, the determination engine 142 can determine whether the interaction condition(s) 208 should be stored in the interaction condition(s) database 145 prior to the interaction condition(s) 208 being stored in the interaction condition(s) database 145. For example, if a given Internet resource is accessed via a proactive content feed, then it is likely the interaction condition(s) 208 will indicate a shorter duration of access and/or less stringent scrolling condition(s) need to be satisfied for rendering the related content interface notification, and the determination engine 142 can provide an indication to store the interaction condition(s) 208. In contrast, if the user accesses a given Internet resource by entering a URL into a search bar (e.g., www.exampleurl.com), then it is likely the interaction condition(s) 208 will indicate very long duration of access and/or very stringent scrolling condition(s) need to be satisfied for rendering the related content interface notification, and the determination engine 142 can provide an indication that the interaction condition(s) 208 should not be stored in the interaction condition(s) database 145. In other words, the determination engine 142 can prevent interaction condition(s) from being stored, for the Internet resource and for that navigational path—or can store “null” interaction condition(s), where the “null” interaction condition(s) indicate that no related content interface indication should be provided for the Internet resource and for that navigational path.

In some other implementations, the determination engine 142 can determine whether the interaction condition(s) engine 141 should even determine the interaction condition(s) 208 based on the predicted output (e.g., a portion of the predicted output different than that used to determine the interaction condition(s) 208). For example, assume the predicted output 207 includes predicted probabilities, but that each of the predicted probabilities fail to satisfy a threshold for determining interaction condition(s) 208 using the interaction condition(s) engine 141. In this example, the determination engine 142 can analyze the predicted probabilities of the predicted output 207 and instruct the interaction condition(s) engine 141 to halt any processing and/or determination of the interaction condition(s) 208. Thus, by employing the determination engine 142, the prediction(s) engine 140 can prevent unnecessary processing, thereby conserving computational resources.

Referring back to FIG. 1, the related content generation engine 150 can identify related content for inclusion in a related content interface notification. The related content generation engine 150 can identify related content, for the related content interface notification, based on how many users visit both the accessed Internet resources and the related Internet resources (optionally in close temporal proximity), an extent of overlap in content of the accessed Internet resources and the related Internet resources (e.g., topics of the Internet resources), and/or how frequently both the accessed Internet resources and the related Internet resources co-occur in search results. The related content generation engine 150 can identify related Internet sources utilizing similar techniques as related content attribute(s) engine 132. For example, for a webpage for Example Airline, assume a webpage for Hypothetical Airline frequently co-occurs with search results for flight information along with Example Airline. Further assume that, responsive to receiving the search results for the flight information, users generally view the webpage for Example Airline, and subsequently view the webpage for Hypothetical Airline. Based on both the co-occurrence of the webpage for Example Airline and the webpage for Hypothetical Airline and the access of both webpages, the related content generation engine 150 can determine the webpage for Example Airline and the webpage for Hypothetical Airline are related. Further, a strength of the relationship between the webpage for Example Airline and the webpage for Hypothetical Airline can be based on a temporal proximity between accessing the webpages. For example, if the user accesses the webpage for Example Airline and immediately thereafter accesses the webpage for Hypothetical Airline, then the strength of relationship can be stronger than if the user accesses one or more other webpages in the intermediate. In this manner, the related content attribute(s) engine 132 can leverage information processed by the related content generation engine 150.

The request engine 160 can handle requests received, via one or more of the networks 190, from the client device 110. For example, FIG. 2B depicts some components of FIG. 1, and example interactions that can occur between the components, in accordance with various implementations. The internet resource access engine 111 of the client device can determine a user of the client device 110 accesses a given Internet resource, and can transmit a request 209 to the peek content system 180 via one or more of the networks 190. The request 209 can include an indication of the given Internet resource (e.g., a URL or other URI) and, optionally, a navigation path utilized to access the given Internet resource. In some implementations, the request engine 160 can process the request 209 by accessing the interaction condition(s) database 145 to retrieve interaction conditions(s) 208 based on the internet resources accessed at the client device 110 and, optionally, based on the navigation path utilized for accessing the Internet resource. The interaction condition(s) 208 can be previously stored in the interaction condition(s) database 145 based on one or more techniques described herein (e.g., as described with respect to FIG. 2A). In other implementations, interaction condition(s) 208 for the given Internet resource may not be stored in the interaction condition(s) database 145, and the peek content system 180 may determine the interaction condition(s) 208 in response to receiving the request 209. Further, the request engine 160 can also provide the indication of the given Internet resource to the related content generation engine 150 to identify related content 210 for inclusion in the related content interface notification. In some implementations, the related content 210 for the given Internet resource can be determined prior to receiving the request 209. In other implementations, the related content 210 for the given Internet resource can be determined in response to receiving the request 209.

In some implementations, the peek content system 180 can transmit the interaction condition(s) 208 and/or the related content 210 to the rendering engine 112 of the client device 110 in response to determining the interaction condition(s) 208. When the client device 110 determines interaction condition(s) 208 are satisfied, the rendering engine 112 can render a related content interface notification 211, including the related content 210. In some other implementations, the peek content system 180 can transmit the interaction condition(s) 208 to the rendering engine 112 of the client device 110, but refrain from transmitting the related content 210 to the rendering engine 112 until the peek content system 180 receives an indication from the client device 110 that that the interaction condition(s) 208 are satisfied. For example, if the interaction condition(s) 208 are “less aggressive” due to a navigation path indicating the user accessed the Internet resource responsive to entering a URL for the Internet resource, then it is less likely the interaction condition(s) 208 will be satisfied, and the peek content system 180 can refrain from wasting network resources by withholding transmission of the related content 208. As another example, if the interaction condition(s) 208 include a duration of access of fifty seconds and/or scrolling conditions of 95% of the Internet resource due to a navigation path indicating the user accessed the Internet resource responsive to entering a URL for the Internet resource, then the peek content system 180 can refrain from transmitting the related content 208 for a certain period of time (e.g., forty-five seconds of the fifty second duration of access) or until certain scrolling condition(s) are met as the interaction condition(s) (e.g., 85% of the 95% scrolling condition). Thus, computational resources can be conserved by refraining from transmitting the related content 210 to the client device 110 in scenarios when the interaction condition(s) 208 are “less aggressive” as compared to immediately transmitting both the interaction condition(s) and the related content 210 in response to determination thereof by the peek content system 180.

In some other implementations, the peek content system 180 can transmit the interaction condition(s) 208 to the to the rendering engine 112 of the client device 110, and transmit the related content 210 to the client device 110 for pre-caching by the pre-caching engine 113 until the interaction condition(s) 208 are satisfied. The pre-caching engine 113 can store the related content 210 in one or more databases (not depicted) of the client device 110. In some versions of those implementations, determining whether to pre-cache (and/or an extent of the pre-caching), at the client device 110 viewing the given Internet resource, the related content 210 can be based on the interaction condition(s) 208. For example, it can be determined to not pre-cache the related content 210 when the determined interaction condition(s) 208 for the accessed Internet resource include a greater than thirty second duration, to pre-cache to a first extent when the interaction conditions include a fifteen to thirty second duration, and to pre-cache to a greater extent (e.g., more related content item(s) and/or a greater extent of related content item(s)) when the interaction conditions include a less than fifteen second duration. By pre-caching the related content 210, latency in rendering the related content 210 can be reduced if the related content 210 is selected in the related content interface notification 211.

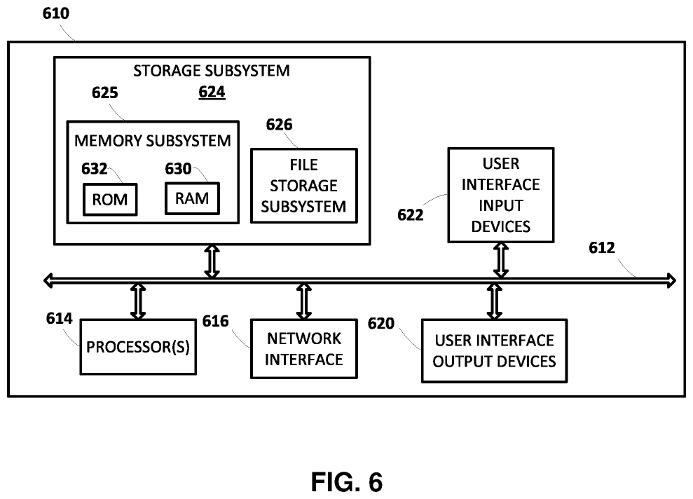

FIG. 3 depicts a flowchart illustrating an example 300 method of training a machine learning model, in accordance with various implementations. For convenience, the operations of the method 300 are described with reference to a system that performs the operations. This system of method 300 includes one or more processors and/or other component(s) of a computing device (e.g., a combination of client device 110 of and peek content system 180 of FIGS. 1, 2A, and 2B, computing device 610 of FIG. 6, one or more servers, and/or other computing devices). Moreover, while operations of the method 300 are shown in a particular order, this is not meant to be limiting. One or more operations may be reordered, omitted, or added.

At block 352, the system determines whether an Internet resource is accessed. If, at an iteration of block 352, the system determines that an Internet resource is not accessed, then the system can continue monitoring for access of an electronic resource at block 352. If, at an iteration of block 352, the system determines that an Internet resource is accessed, then the can proceed to block 354. At block 354, the system causes a given client device to render, while a user is consuming the accessed Internet resource, a related content interface notification. At block 356, the system determines a reward based on one or more user interactions (or lack thereof) with the related content interface notification.

In some implementations, the one or more user interactions (or the lack thereof) used in determining the reward can be based on an extent of the one or more user interactions with the related content interface notification rendered for a given Internet resource, a duration of access of the given Internet resource subsequent to rendering the related content interface notification and prior to one or more of the user interactions with the related content interface notification, and/or scrolling condition(s) for the Internet resource (e.g., whether scrolling has occurred, an extent of the scrolling, a speed of the scrolling, and/or a direction of the scrolling) subsequent to rendering the related content interface notification and prior to one or more of the user interactions with the related content interface notification. For example, assume a user accesses a webpage for Hypothetical Café, a hypothetical restaurant in Louisville, Ky. that serves vegan cuisine. Further assume a related content interface notification, that includes links to and/or information of other webpages related to the webpage for Hypothetical Café, is rendered while the user is viewing the webpage for Hypothetical Café via a user interface of the client device of the use.

In some of those implementations, the reward can vary based in part on the extent of the one or more user interactions (i.e., how the user interacts with the related content interface notification). For example, if the user accesses underlying content of an additional webpage linked to in the related content interface notification rendered while the user is viewing the webpage for Hypothetical Café, then the system can determine a reward that is a very strong indicator for provision of the related content interface notification (e.g., 1.0). In contrast, if the user dismisses the related content interface notification rendered while the user is viewing the webpage for Hypothetical Café, then the system can determine a reward that is a very poor indicator for provision of the related content interface notification (e.g., 0.0). However, if the user does not dismiss or interact with the related content interface notification rendered while the user is viewing the webpage for Hypothetical Café, then the system can determine a reward that is a poor indicator for provision of the related content interface notification (e.g., 0.2).

In various implementations, the reward can also vary based in part on the duration of access of the given Internet resource subsequent to rendering the related content interface notification and prior to one or more of the user interactions (or the lack thereof) with the related content interface notification. For example, if the user views the webpage for Hypothetical Café for only ten seconds subsequent to rendering the related content interface notification and before interacting with the related content interface notification (e.g., as described in FIGS. 5A-5D), then the system can determine a reward that is a strong indicator for provision of the related content interface notification (e.g., 0.8). In contrast, if the user views the webpage for Hypothetical Café for more than sixty seconds subsequent to rendering the related content interface notification and before interacting with the related content interface notification, then the system can determine a reward that is a mild indicator for provision of the related content interface notification (e.g., 0.4).

In various implementations, the reward can also vary based in part on the scrolling condition(s) for the Internet resource (e.g., whether scrolling has occurred, an extent of the scrolling, a speed of the scrolling, and/or a direction of the scrolling) subsequent to rendering the related content interface notification and prior to one or more of the user interactions (or the lack thereof) with the related content interface notification. For example, if the user views the webpage for Hypothetical Café for only ten seconds subsequent to rendering the related content interface notification and without scrolling (or quickly scrolling to the bottom of the webpage for Hypothetical Café) before interacting with the related content interface notification (e.g., as described in FIGS. 5A-5D), then the system can determine a reward that is a very strong indicator for provision of the related content interface notification (e.g., 1.0) even though the user may not have accessed any underlying content of the other webpages included in the related content interface notification. Further, if the user views the webpage for Hypothetical Café for more than sixty seconds subsequent to rendering the related content interface notification and slowly scrolls to the bottom of the webpage for Hypothetical Café without ever interacting with the related content interface notification, then the system can determine a reward that is a poor indicator for provision of the related content interface notification (e.g., 0.2).

In this manner, the one or more user interactions (or the lack thereof) used in determining the reward can be based on an extent of the one or more user interactions with the related content interface notification rendered for a given Internet resource, a duration of access of the given Internet resource prior to one or more of the user interactions with the related content interface notification, and/or scrolling condition(s) for the Internet resource prior to one or more of the user interactions with the related content interface notification. In some additional and/or alternative implementations, the system can also determine a penalty based on one or more of the user interactions with the related content interface notification. For example, in instances where the reward is a very poor indicator (e.g., the user dismisses the related content interface notification and/or other instances) and/or poor indicator (e.g., the user does not interact with the related content interface notification), the system can determine a penalty (e.g., −1.0). In these instances, the penalty can be combined with any reward to determine an overall reward.

At block 358, the system can update a machine learning model based on the determined reward. Thus, the machine learning model can be trained for use in determining whether and/or when to provide a related content interface notification based on a given Internet resource, which can vary for each Internet resource. Although the machine learning model of FIG. 3 is described as being updated based on a reward via a reinforcement learning technique, it should be understood that is not meant to be limiting. In some additional and/or alternative implementations, the machine learning model can be updated using other machine learning techniques, such as supervised learning techniques, as described herein (e.g., with respect to FIG. 1).

Moreover, in some implementations, the machine learning model can be implemented by a client device of a user, by one or more servers in communication with the client device of the user via one or more networks (e.g., network(s) 190 of FIG. 1), and/or by the client device in conjunction with one or more of the servers. Further, in some implementations, the machine learning model can also be trained based on one or more user interactions of a plurality of additional users that accessed the same webpage as the user, such that the machine learning model is a global machine learning model. In some versions of those implementations, the machine learning model can be further trained based on one or more user interactions of a given user, such that the global machine learning model is tailored to the given user, thereby resulting in a personalized machine learning model.

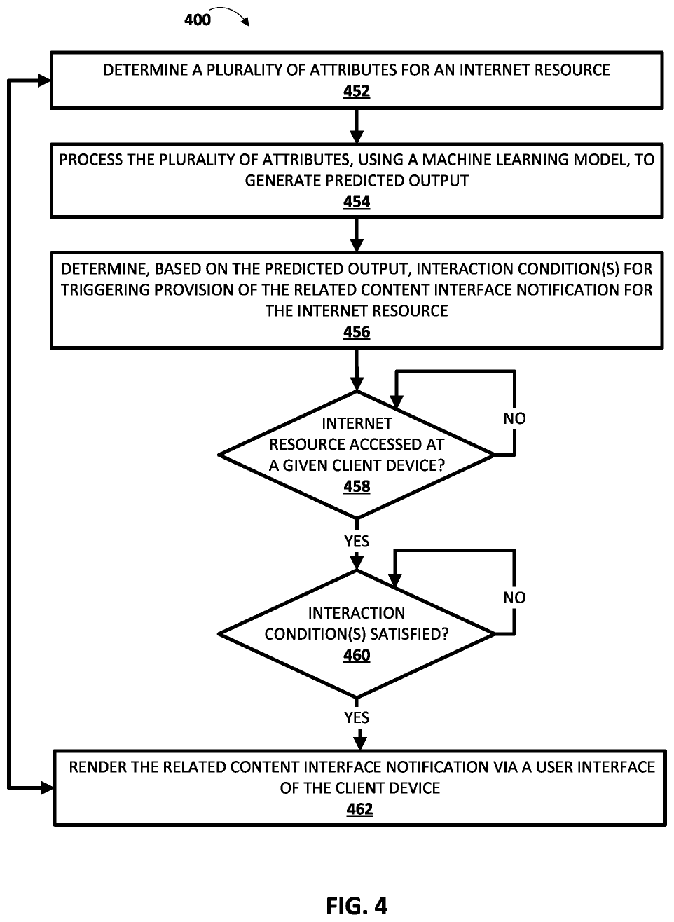

FIG. 4 depicts a flowchart illustrating an example method 400 of determining whether and/or when to render a related content interface notification, in accordance with various implementations. For convenience, the operations of the method 400 are described with reference to a system that performs the operations. This system of method 400 includes one or more processors and/or other component(s) of a computing device ((e.g., a combination of client device 110 of and peek content system 180 of FIGS. 1, 2A, and 2B, computing device 610 of FIG. 6, one or more servers, and/or other computing devices). Moreover, while operations of the method 400 are shown in a particular order, this is not meant to be limiting. One or more operations may be reordered, omitted, or added.

At block 452, the system determines a plurality of attributes for an Internet resource. The plurality of attributes for the Internet resource can include, for example, content attribute(s), navigation attribute(s), global historical attribute(s), personal historical attribute(s), and/or related content attribute(s). Each of the attributes are described in greater detail herein (e.g., with respect to FIGS. 1, 2A, and 2B), and how each of the attributes influence whether and/or when a related content interface notification is rendered is also described in greater detail herein (e.g., with respect to FIGS. 5A-5D).

At block 454, the system processes the plurality of attributes, using a machine learning model, to generate predicted output. For example, the system can generated the predicted output by applying the plurality of attributes as input across the machine learning model. Further, the machine learning model can be trained based on one or more interactions (or lack thereof) of a given user and/or a plurality of additional users with previously provided related content interface notifications (e.g., as described in more detail in FIGS. 1 and 3).

At block 456, the system determines, based on the predicted output, one or more interactions for triggering provision of the related content interface notification for the Internet resource. The interaction condition(s) for a given Internet resource can include, for example, a duration of access of the given Internet resource (e.g., elapsed time since the given Internet resource was requested, retrieved, or rendered) and/or scrolling condition(s) (e.g., whether scrolling has occurred, an extent of the scrolling, a speed of the scrolling, and/or a direction of the scrolling). The interaction condition(s) are dynamic in that they can vary from Internet resource to Internet resource and/or can even vary for a single Internet resource (e.g., in dependence on the navigation path in accessing the Internet resource and/or the client device and/or user account accessing the Internet resource). As one example, for a first webpage, interaction conditions can include a duration of access that indicate 20 seconds for access of the first webpage and/or scrolling conditions that indicate scrolling through 50% of the first webpage. In contrast, for a second webpage, interaction conditions can include a duration of access that indicate 15 seconds of access for the second webpage and/or scrolling conditions that indicate scrolling through 20% of the second webpage. As another example, for a third webpage, and for access of the third webpage via a first navigation path (e.g., query-independent path via a content feed of a given client device), interaction conditions can include a duration of access of 10 seconds for the third webpage. However, for the third webpage, and for access of the third webpage via a second navigation path (e.g., query-dependent path via a navigational query submitted via the given client device), interaction conditions can include a duration of access of 30 seconds for the third webpage.

At block 458, the system determines whether an Internet resource is accessed at a given client device of a user. If, at an iteration of block 458, the system determines an Internet resource is not accessed at the given client device of the user, then the system can wait for access of an Internet resource at block 458. If, at an iteration of block 458, the system determines an internet resource is accessed at the given client device of the user, then the system can, in some implementations, proceed to block 460.

At block 460, the system determines whether one or more of the interaction conditions for the Internet resource are satisfied. It is noted that, when multiple interaction conditions are determined for a given Internet resource, satisfaction of the interaction conditions can be determined when any one of the interaction conditions is satisfied or, alternatively, when a combination of one or more (e.g., a subset or all) of the interaction conditions is satisfied. If, at an iteration of block 460, the system determines one or more of the interaction conditions are not satisfied, then the system can continue monitoring for satisfaction of one or more of the interaction conditions for the Internet resource at block 460. If, at an iteration of block 460, the system determines one or more of the interaction conditions are not satisfied, then the system can proceed to block 462.

At block 462, the system renders the related content interface notification via a user interface of the client device. In some implementations, upon rendering of the related content interface notification, the system can monitor for one or more user interactions with the related content interface notification, and update the machine learning model based on one or more of the user interactions during inference. In some versions of those implementations, the system can determine a reward based on one or more of the user interactions (e.g., as described in FIGS. 1 and 3), and can update the machine learning model based on the determined reward. In some other versions of those implementations, the system can determine ground truth output for a given related content interface notification based on one or more of the user interactions (e.g., as described in FIGS. 1 and 3), and can update the machine learning model based on comparing the ground truth output to the predicted output. In this manner, the machine learning model can be continuously updated based one or more of the user interactions with the related content interface notification.

FIGS. 5A-5D depict various non-limiting examples of related content interface notifications, in accordance with various implementations. A client device 510 is depicted and includes a user interface 580. The user interface 580 of the client device 510 includes various system interface elements 591, 592, and 593 (e.g., hardware and/or software interface elements) that may be interacted with by the user to cause the client device 510 to perform one or more actions. Further, the user interface 580 of the client device 510 enables a user to interact with content rendered on the user interface 580 by touch input (e.g., by directing user input to the user interface 580) and/or by voice input (e.g., by selecting microphone interface element 594—or just by speaking without necessarily selecting the microphone interface element 594 (i.e., an automated assistant executing at least in part on the client device 510 may monitor for one or more terms or phrases and/or other conditions to activate voice input)).

Notably, FIGS. 5A-5D depict various example of whether and/or when to render the related content interface notifications on the user interface 580 of the client device 510 based on one or more interaction conditions. As described herein, determining one or more of the interaction conditions for a given webpage can be based on a plurality of attributes, and determining whether to provide the related interface notifications can vary from Internet resource to Internet resource and/or can even vary for a single Internet resource (e.g., in dependence on the navigation path in accessing the Internet resource and/or the client device and/or user account accessing the Internet resource) based on whether one or more of the interaction conditions are satisfied. The plurality of attributes can include, for example, content attribute(s), navigation attribute(s), global historical attribute(s), personal historical attribute(s), and/or related content attribute(s).

Turning initially to FIG. 5A, a webpage for “Hypothetical Café” 530A, a hypothetical restaurant in Louisville, Ky. that serves vegan cuisine, is rendered on the user interface 580 of the client device 510, and is associated with URL 525A (“www.exampleurl1.com/?ref=content-feed”). As indicated by navigation path 520A, the webpage for Hypothetical Café 530A was accessed based on a user selection of the webpage for Hypothetical Café 530A from a content feed of the client device 510. The content feed of the client device 510 can include, for example, a social media feed for a social media account associated with a user of the client device 510, a proactive content feed for a home screen of the client device 510, and/or other content feeds accessible by the client device 510. In some implementations, and as shown in FIG. 5A, the URL 525A can be embedded with an indication of the navigation path 520A (e.g., “/?ref=content-feed”) used to access the webpage for Hypothetical Café 530A.

In some implementations, one or more of the interaction conditions for the webpage for Hypothetical Café 530A of FIG. 5A can be based at least in part on navigation attribute(s). The navigation attribute(s) for the webpage for Hypothetical Café 530A in FIG. 5A can be based on the navigation path 520A that indicates the user accessed the webpage for Hypothetical Café 530A via a content feed (e.g., query-independent navigation path). Based on the user accessing the webpage for Hypothetical Café 530A via the content feed, the related content interface notification 550A is more likely to be provided and/or will be provided with “more aggressive” interaction conditions than if the given Internet resource is accessed as a result of a query (e.g., as described in FIGS. 5B and 5C).

Notably, in FIG. 5A, the client device 510 has rendered a related content interface notification 550A, via the user interface 580, as an expanded “peek” even though a user has not scrolled (or minimally scrolled) through the webpage for Hypothetical Café 530A (e.g., as indicated by scroll bar 585; address information, contact information, and/or hours of operation for Hypothetical Café being displayed on the user interface 580; a top portion of a menu for Hypothetical Café being displayed, such as only Appetizers 532 and a first portion of Entrees 534; and/or other scrolling condition signals). However, even though the user has not scrolled through the webpage for Hypothetical Café 530A, the client device 510 can still render the related content interface notification 550A on the user interface 580 based on one or more of the interaction conditions being satisfied. Thus, the navigation path 520A can provide an indication that the user may be generally browsing the content feed for webpages for restaurants (or more particularly webpages for vegan restaurants), and the related content interface notification 550A can enable the user to efficiently navigate to other webpages for restaurants with having to return to the content feed to identify other webpages for restaurants and/or other related content.

Moreover, in some implementations, one or more of the interaction conditions for the webpage for Hypothetical Café 530A of FIG. 5A can be based at least in part on historical interaction attribute(s). The historical interaction attribute(s) can include, for example, personal historical interaction attribute(s) and/or global historical interaction attribute(s). For example, with respect to the personal historical interaction attribute(s), assume that the user has previously accessed a plurality of other webpages from the content feed, and further assume that the user's duration of access for each of the plurality of other webpages is only between ten and fifteen seconds. In this example, the interaction conditions may indicate that the related content interface notification 550A should be provided after a five second duration of access, regardless of any scrolling conditions, because it is likely the user will exit the webpage for Hypothetical Café 530A within ten to fifteen seconds of initially accessing the webpage for Hypothetical Café 530A. As another example, with respect to the global historical interaction attribute(s), assume that a plurality of additional users (e.g., in addition to the user of the client device 510 or also including the user the user of the client device 510) previously accessed a plurality of other webpages related to restaurants, and further assume that the average duration of access for the other webpages for the plurality of additional users is only between eight and ten seconds. In this example, the interaction conditions may indicate that the related content interface notification 550A should be provided after a three second duration of access, regardless of any scrolling conditions, because it is likely the user will also exit the webpage for Hypothetical Café 530A within eight to ten seconds of initially accessing the webpage for Hypothetical Café 530A. Thus, the historical interaction attribute(s) can provide an indication of how the user of the client device 510 and/or a plurality of additional users generally browse for and/or interact with webpages, and the related content interface notification 550A can enable the user to efficiently navigate to other webpages for restaurants with having to return to the content feed to identify other webpages for restaurants and/or other related content.

The related content interface notification 550A can include an interaction element 550 and related content 551A and 552A. The interaction element 550 can, upon interaction (e.g., via touch input swiping up on the interaction element 550 or voice input to view more of the related content), enable the user of the client device 510 to view additional related content (e.g., as indicated generally by 553A). For example, upon interaction with the interaction element 550, the related content interface notification 550A can consume a larger portion of the user interface 580, such that it overlays and/or supplants the user interface 580. Further, the interaction element 550 can, upon interaction (e.g., via touch input swiping down on the interaction element 550 or voice input to dismiss the related content interface notification 550A), enable the related content interface notification 550A to be dismissed.

Further, the related content included in the related content interface notification 550A can be identified using a related content generation engine (e.g., related content generation engine 150 of FIG. 1). The related content can include information about the related content (e.g., description of the related content, operating hours of a business associated with the related content, and so on), links to underlying content associated with the related content (e.g., another webpage associated with the related content), hyperlinked text for accessing the underlying content associated with the related content, actionable content (e.g., phone numbers, addresses, and/or other interface elements that, when selected, cause the client device 510 to perform one or more actions), and/or other information. For example, the related content 551A and 552B of FIG. 5A includes an indication of other hypothetical vegan restaurants located in Louisville, Ky. (e.g., “Example Vegan Restaurant” and “All About the Beets”). Further, the related content 551A and 552B of FIG. 5A include links (e.g., “www.exampleurl2.com” and “www.exampleurl3.com”, respectively), and descriptions for the related content 551A and 551B (e.g., “Farm-to-Table Vegan Restaurant” and “Specializes in Beet Dishes”, respectively). Thus, the user can interact with the related content interface notification 550A rendered as an expanded “peek” by interacting with the related content 551A and 551B, or by interacting with the interaction element 550 to view additional related content (e.g., as indicated generally by 553A) or dismiss the related content interface notification 550A.

Turning now to FIG. 5B, the webpage for Hypothetical Café 530A is rendered on the user interface 580 of the client device 510. However, in comparison with FIG. 5A, the webpage for Hypothetical Café 530A is associated with URL 525B (“www.exampleurl1.com/?vegan-cuisine-louisville-ky”). As indicated by navigation path 520B, the webpage for Hypothetical Café 530A was accessed based on a query of “Vegan Cuisine Louisville, Ky.” submitted at the client device 510 (e.g., typed or spoken). The query of “Vegan Cuisine Louisville, Ky.” can be classified as a broader query as compared to other queries (e.g., a navigational query described in FIG. 5C). In some implementations, and as shown in FIG. 5B, the URL 525B can be embedded with an indication of the navigation path 520B (e.g., “/?vegan-cuisine-louisville-ky”) used to access the webpage for Hypothetical Café 530A.

In some implementations, one or more of the interaction conditions for the webpage for Hypothetical Café 530A of FIG. 5B can be based at least in part on navigation attribute(s), the one or more of the interaction conditions can vary from those of FIG. 5A. The navigation attribute(s) for the webpage for Hypothetical Café 530A in FIG. 5B can be based on the navigation path 520B that indicates the user accessed the webpage for Hypothetical Café 530A via a query (e.g., query-dependent navigation path). Based on the user accessing the webpage for Hypothetical Café 530A via the query, the related content interface notification 550A is more likely to be provided and/or will be provided with “less aggressive” interaction conditions than if the given Internet resource is accessed via a content feed (e.g., as described in FIG. 5A), but “more aggressive” interaction conditions than if the given Internet resource is accessed via a more narrow query (e.g., a navigational query described in FIG. 5C).

Notably, in FIG. 5B, the client device 510 has rendered a related content interface notification 550A, via the user interface 580, as an expanded “peek” once the user has scrolled through a certain portion (e.g., 50%) of the webpage for Hypothetical Café 530A (e.g., as indicated by scroll bar 585; a middle portion of a menu being displayed, such as a second portion of Entrees 534, Desserts 536, and a first portion of Drinks 538; and/or other scrolling condition signals). Further, the interaction conditions can also include a duration of access for the webpage for Hypothetical Café 530A, and the client device 510 can render the related content interface notification 550A, via the user interface 580, based on the duration of access and/or the scrolling conditions. For example, if the user views the webpage for Hypothetical Café 530A for forty seconds without scrolling through the webpage for Hypothetical Café 530A, then the client device 510 can render the related content interface notification 550A via the user interface 580. As another example, if the user only views the webpage for Hypothetical Café 530A for twenty seconds, but has already scrolled through 50% of the webpage for Hypothetical Café 530A, then the client device 510 can render the related content interface notification 550A via the user interface 580. Thus, the interaction conditions for a given Internet resource can be various combinations of duration of access, scrolling conditions, navigations paths, and/or other conditions.

Turning now to FIG. 5C, the webpage for Hypothetical Café 530A is rendered on the user interface 580 of the client device 510. However, in comparison with FIGS. 5A and 5B, the webpage for Hypothetical Café 530A is associated with URL 525C (“www.exampleurl1.com/?hypothetical-cafe-louisville”). As indicated by navigation path 520C, the webpage for Hypothetical Café 530A was accessed based on a query of “Hypothetical Café Louisville” submitted at the client device 510 (e.g., typed or spoken). The query of “Hypothetical Café Louisville” can be classified as a navigational query as compared to other broader queries (e.g., the query of “Vegan Cuisine Louisville, Ky.” described in FIG. 5B). In some implementations, and as shown in FIG. 5C, the URL 525C can be embedded with an indication of the navigation path 520C (e.g., “/?hypothetical-cafe-louisville”) used to access the webpage for Hypothetical Café 530A.

In some implementations, one or more of the interaction conditions for the webpage for Hypothetical Café 530A of FIG. 5C can be based at least in part on navigation attribute(s), the one or more of the interaction conditions can vary from those of FIGS. 5A and 5B. The navigation attribute(s) for the webpage for Hypothetical Café 530A in FIG. 5C can be based on the navigation path 520C that indicates the user accessed the webpage for Hypothetical Café 530A via a navigational query (e.g., query-dependent navigation path). Based on the user accessing the webpage for Hypothetical Café 530A via the navigational query, the related content interface notification 550A is more likely to be provided and/or will be provided with “less aggressive” interaction conditions than if the given Internet resource is accessed via a content feed or a broader query (e.g., as described in FIGS. 5A and 5B). In some other implementations when a navigation path indicates the user accesses a webpage via a navigational query, the interaction conditions can indicate a related content interface notification should not be rendered (e.g., related content interface notification 550A of FIG. 5C depicted as a dashed-line). In some implementations, the interaction conditions can also include an indication as to how to render the related content interface notification 550A (e.g., how much related content, if any, to include in the related content interface notification 550A).

Notably, in FIG. 5C, the client device 510 has rendered a related content interface notification 550A, via the user interface 580, as a condensed “peek” once the user has scrolled through a certain portion (e.g., 100%) of the webpage for Hypothetical Café 530A (e.g., as indicated by scroll bar 585; some disclaimers and other information about Hypothetical Café; and/or other scrolling condition signals). Further, the interaction conditions can also include a duration of access for the webpage for Hypothetical Café 530A, and the client device 510 can render the related content interface notification 550A, via the user interface 580, based on the duration of access and/or the scrolling conditions. However, in comparison with FIGS. 5A and 5B, the related content interface notification 550A in FIG. 5C does not include any of the related content 551A and 551B, simply an indication that additional related content (e.g., as indicated generally by 553A) is available (e.g., a condensed “peek”) as indicated by the interaction conditions. For example, if the user has viewed the webpage for Hypothetical Café 530A for more than ninety seconds without scrolling through the webpage for Hypothetical Café 530A or has scrolled through a certain portion less than that specified by the interaction conditions, then the client device 510 can render the related content interface notification 550A via the user interface 580. As another example, if the user views the webpage for Hypothetical Café 530A for more than seventy seconds, and has already scrolled to the bottom of the webpage for Hypothetical Café 530A, then the client device 510 can render the related content interface notification 550A via the user interface 580. Thus, the interaction conditions for a given Internet resource can be various combinations of duration of access, scrolling conditions, navigations paths, and/or other conditions.

It should be noted that although the related content interface notification 550A of FIG. 5C is the only one shown as a condensed “peek”, it should be not that is for exemplary purposes and is not meant to be limiting. For example, the related content interface notification 550A of FIG. 5A and/or 5B can also be rendered as a condensed “peek”. Moreover, it should be noted that FIGS. 5A-5C depict the same webpage for Hypothetical Café 530A, but the interaction conditions are different based on different navigation paths, and as a result, the client device renders the related content interface notification 550A when these different interaction conditions are satisfied. Further, although each “peek” of FIGS. 5A-5C are rendered at the bottom of the user interface 580, it should be noted that each “peek” can be rendered at the top of the user interface 580 or on either side of the user interface 580.

Turning now to FIG. 5D, a webpage for “Example Airline” 530A is rendered on the user interface 580 of the client device 510, and is associated with URL 525D (“www.exampleurl4.com/?example-airline-flights-from-sdf-to-dca”). As indicated by navigation path 520D, the webpage for Hypothetical Café 530A was accessed based on a query of “Example Airline Flights from SDF to DCA” submitted at the client device 510 (e.g., typed or spoken). The query of “Example Airline Flights from SDF to DCA” can be classified as a navigational query as compared to other broader queries (e.g., a query of “Flights from SDF to DCA”). In some implementations, and as shown in FIG. 5D, the URL 525D can be embedded with an indication of the navigation path 520C (e.g., “/?example-airline-flights-from-sdf-to-dca”) used to access the webpage for Example Airline 530D.

In some implementations, one or more of the interaction conditions for the webpage for Example Airline 530D of FIG. 5D can be based at least in part on navigation attribute(s). The navigation attribute(s) for the webpage for Example Airline 530D in FIG. 5D can be based on the navigation path 520D that indicates the user accessed the webpage for Example Airline 530D via a navigational query (e.g., query-dependent navigation path). Based on the user accessing the webpage for Example Airline 530D via the navigational query, the related content interface notification 550A is more likely to be provided and/or will be provided with “less aggressive” interaction conditions than if the given Internet resource is accessed as a result of a content feed or a broader query.

However, in some implementations, one or more of the interaction conditions for the webpage for Example Airline 530D of FIG. 5D can be based at least in part on one or more content attributes. One or more of the content attributes can include, for example, type attribute(s) that indicate type(s)/verticals, of a plurality of disparate types, to which the given Internet resource conforms, lower-dimensional embeddings of at least some of the content of the given Internet resource, structural attributes of at least some of the content of the given Internet resource, and/or other content attributes. For example, content attributes for the webpage for Example Airline 530D in FIG. 5D can include a travel type, or more specifically air travel type, underlying content of the webpage for Example Airline 530D, lower-dimensional embeddings of at least some of the content of the of the webpage for Example Airline 530D (e.g., flight dates/times, ticket costs, flight numbers, etc.), and/or other content attributes.

Moreover, in some implementations, one or more of the interaction conditions for the webpage for Example Airline 530D of FIG. 5D can be based at least in part on one or more related content attributes. The related content attributes can be based on one or more related Internet resources that are linked-to in the related content interface notification for the Internet resource (or that are rendered in response to selection of the related content interface notification). For example, the related content attributes can be based on determined query-independent measure(s) for one or more of related Internet resources. The query-independent measure(s) of an Internet resource can be based on, for example, frequency of access of the Internet resource, in-bound link(s) to the Internet resource, and/or other query-independent properties of the Internet resource. The related content attributes for a related Internet resource can additionally or alternatively be based on a strength of relationship between the related Internet resource and the given Internet resource. The strength of relationship between the related Internet resource and the given Internet resource can be based on, for example, how many users visit both of the Internet resources (optionally in close temporal proximity), an extent of overlap in content of the Internet resources (e.g., topics of the Internet resources), and/or how frequently both Internet resources co-occur in search results. For example, if users that view the webpage for Example Airline 530D typically subsequently view a webpage for Hypothetical Airline and/or view webpages of other pages of a travel type (optionally in close temporal proximity), then the related content attribute can indicate users typically view these other webpages and/or that they co-occur in search results responsive to a query about air travel.

Notably, in FIG. 5D, the client device 510 has rendered a related content interface notification 550D, via the user interface 580, as an expanded “peek” even though a user has not scrolled (or minimally scrolled) through the webpage for Example Airline 530D (e.g., as indicated by scroll bar 585; contact information for Example Airline being displayed on the user interface 580; a top portion of flight dates/times being displayed, such as only Flights from SDF to DCA 540; and/or other scrolling condition signals). However, even though the user has not scrolled through the webpage for Example Airline 530D, the client device 510 can still render the related content interface notification 550A on the user interface 580 based on one or more of the interaction conditions being satisfied. Further, and in comparison with FIG. 5C, although the user accessed webpage for Example Airline 530D via the navigational query of “Example Airline Flights from SDF to DCA”, the interaction conditions are “more aggressive”. The interaction conditions for the webpage for Example Airline 530D can be “more aggressive” than those for the webpage for Hypothetical Café 530A based on the content attributes and/or related content attributes for the webpage for Example Airline 530D despite the user having navigated to both the webpage for Hypothetical Café 530A and the webpage for Example Airline 530D via navigational queries (e.g., “Hypothetical Café Louisville” and “Example Airline Flights from SDF to DCA”, respectively). For example, the interaction conditions for the webpage for Example Airline 530D can indicate that the related content interface notification 550D should be rendered after a 5 second duration of access for the webpage for Example Airline 530D with no scrolling conditions. Further, the interaction conditions can indicate the related content interface notification 550D should be rendered as an expanded “peek” rather than a condensed “peek” (e.g., as described in FIG. 5C).

The related content interface notification 550D can include an interaction element 550 and related content 551D. The interaction element 550 can, upon interaction (e.g., via touch input swiping up on the interaction element 550 or voice input to view more of the related content), enable the user of the client device 510 to view additional related content (e.g., as indicated generally by 553D). For example, upon interaction with the interaction element 550, the related content interface notification 550D can consume a larger portion of the user interface 580, such that it overlays and/or supplants the user interface 580. Further, the interaction element 550 can, upon interaction (e.g., via touch input swiping down on the interaction element 550 or voice input to dismiss the related content interface notification 550D), enable the related content interface notification 550D to be dismissed.

Further, the related content included in the related content interface notification 550D can be identified using a related content generation engine (e.g., related content generation engine 150 of FIG. 1). The related content can include information about the related content (e.g., description of the related content, operating hours of a business associated with the related content, and so on), links to underlying content associated with the related content (e.g., another webpage associated with the related content), hyperlinked text for accessing the underlying content associated with the related content, actionable content (e.g., phone numbers, addresses, and/or other interface elements that, when selected, cause the client device 510 to perform one or more actions), and/or other information. For example, the related content 551D of FIG. 5D includes an indication of other airlines offering flights from SDF to DCA (e.g., “Hypothetical Airline”). Further, the related content 551D FIG. 5D includes a link (e.g., “www.exampleurl5”), and descriptions for the related content 551D (e.g., e.g., flight dates/times, ticket costs, flight numbers, etc.). Thus, the user can interact with the related content interface notification 550D rendered as a “peek” by interacting with the related content 551D, or by interacting with the interaction element 550 to view additional related content (e.g., as indicated generally by 553D) or dismiss the related content interface notification 550D.

Although that the interaction conditions described herein with respect to both a duration of access and scrolling condition(s), it should be understood that that client device 510 can render a related content interface notification when only the duration of access is satisfied, when only the scrolling condition(s) are satisfied, and/or a combination of both the duration of access and the scrolling condition(s) are satisfied. In this manner, the interaction conditions are dynamic in that they can even vary for a single Internet resource (e.g., in dependence on a navigation path in accessing the Internet resource, the client device 510, and/or a user account associated with the client device 510 accessing the Internet resource). In this manner, not only are the interaction conditions dynamic in that they can even vary for a single Internet resource (e.g., as described in FIGS. 5A-5C), but the interaction conditions are also dynamic in that they can vary from Internet resource to Internet resource based at least in part on content attribute(s) for the Internet resource (e.g., as described in FIG. 5D). Moreover, although FIGS. 5A-5D are described as utilizing certain interaction conditions and certain attributes, it should be understood that the certain interaction conditions and the certain attributes of FIGS. 5A-5D are provided for exemplary purposes and are not meant to be limiting. Further, the scrolling condition(s) described in FIGS. 5A-5D describe a user through the user interface 580 of the client device 510 while viewing a webpage, it should be understood that the scrolling condition(s) can also include scrolling through a certain percentage of a video while viewing the video, scrolling through a certain percentage of photos while viewing a photo album, and/or other scrolling conditions with respect to particular Internet resources.

FIG. 6 is a block diagram of an example computing device 610 that may optionally be utilized to perform one or more aspects of techniques described herein. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes determining a plurality of attributes for an Internet resource. The plurality of attributes comprise one or more content attributes that are based on content of the Internet resource. The method further includes processing the plurality of attributes, using a machine learning model, to generate predicted output, and determining, based on the predicted output, one or more interaction conditions for triggering provision of a related content interface notification for the Internet resource. The method further includes, responsive to access of the Internet resource by a given client device, and responsive to determining the one or more interaction conditions: causing the given client device to render the related content interface notification in response to determining that the access of the Internet resource satisfies the one or more interaction conditions.

These and other implementations of technology disclosed herein can optionally include one or more of the following features.

In some implementations, the one or more content attributes include a type attribute that indicates a type, of a plurality of disparate types, to which the Internet resource most closely conforms. In some implementations, the one or more content attributes include a structural attribute. In some of versions of those implementations, determining the structural attribute is based on an organizational structure of markup language of the Internet resource. In some implementations, the one or more content attributes include a lower-dimensional embedding of at least some of the content of the Internet resource, the lower-dimensional embedding is generated based on processing the at least some of the content using an additional machine learning model.

In some implementations, the plurality of attributes further include one or more navigation attributes indicating one or more particular attributes for navigating to the Internet resource. In some versions of those implementations determining, based on the predicted output, (a) to provide the related content interface notification for the Internet resource, and (b) the one or more interaction conditions for triggering provision of the related content interface notification, occur prior to access of the Internet resource by the given client device. In some versions of those implementations, causing the given client device to render the related content interface notification in response to determining that the access of the Internet resource satisfies the one or more interaction conditions is further in response to determining that the access of the Internet resource by the given client device is a result of navigation that conforms to the one or more navigation attributes.

In some versions of those implementations, the one or more navigation attributes comprise a path attribute that indicates a given navigational path, of a plurality of navigational paths, for accessing the Internet resource. In some further versions of those implementations, the given navigational path is: a query-based path that indicates accessing the Internet resource responsive to one or more search queries, or a query-independent path that indicates accessing the Internet resource independent of any query. In yet further versions of those implementations, the given navigational path is the query-based path and indicates a breadth of the one or more search queries.

In some implementations, the plurality of attributes further include one or more global historical interaction attributes that indicate measured past extents of past interactions, with previous related content interface notifications, responsive to previous renderings of the previous related content interface notifications for past accesses, by a plurality of client devices, of the Internet resource and/or of additional Internet resources determined to be similar to the Internet resource.

In some implementations, the plurality of attributes further include one or more personal historical interaction attributes that indicate measured past extents of past interactions, by a user of the given client device, with previous related content interface notifications. In some versions of those implementations, the measured past extents of past interactions are with previous related content interface notifications for past accesses of additional Internet resources determined to be similar to the Internet resource.

In some implementations, determining, based on the predicted output, the one or more interaction conditions for triggering provision of the related content interface notification, occurs prior to access of the Internet resource by the given client device. In some versions of those implementations, causing the given client device to render the related content interface notification in response to determining that the access of the Internet resource satisfies the one or more interaction conditions includes transmitting the one or more interaction conditions to the given client device. In some versions of those implementations, transmitting the one or more interaction conditions to the given client device causes the given client device to monitor for occurrence of the one or more interaction conditions during access of the Internet resource at the given client device, and causes the given client device to render the related content interface notification in response to the occurrence of the one or more interaction conditions.

In some implementations, the one or more interaction conditions include a duration of the access of the Internet resource. In some implementations, the one or more interaction conditions include a scrolling condition that indicates whether, during access of the Internet resource, scrolling has occurred, an extent of the scrolling, a speed of the scrolling, or a direction of the scrolling.

In some implementations, the one or more interaction conditions include at least two interaction conditions. Further, access of the Internet resource satisfies the one or more interaction conditions only when each of the at least two interaction conditions are satisfied. In some implementations, the one or more interaction conditions include at least two interaction conditions. Further, access of the Internet resource satisfies the one or more interaction conditions only when either of the at least two interaction conditions are satisfied.

In some implementations, the method further incudes determining, based on the predicted output, whether to provide the related content interface notification for the Internet resource. Further, causing the given client device to render the related content interface is further responsive to determining to provide the related content interface notification for the Internet resource. In some versions of those implementations, the predicted output includes a first output portion that dictates whether to provide the related content interface notification and a second output portion that dictates the one or more interaction conditions for triggering provision of the related content interface notification. In some versions of those implementations, the predicted output dictates the one or more interaction conditions. Further, determining to provide the related interface notification includes determining to provide the related interface notification based on the one or more interaction conditions satisfying one or more conditions.

In some implementations, the related content interface notification includes a link to a related Internet resource or is selectable to cause rendering of the link to the related Internet resource. In some versions of those implementations, the method further includes determining, based on the predicted output, to cause preemptive caching of the related Internet resource, and responsive to determining to provide the related content interface notification for the Internet resource, and responsive to access of the Internet resource by a given client device: further causing the given client device to preemptively cache, locally at the given client device, at least part of the Internet resource prior to rendering the related content interface notification.

In some implementations, the related content interface notification is rendered atop the Internet resource and indicates that related resources are available, but the related content interface notification does not provide any details of the related resources. Further, a single selection of the related content interface notification, via a user input device of the client device, causes details of at least some of the related resources to be rendered atop the Internet resource.

In some implementations, the related content interface notification is rendered atop the Internet resource and provides details on only one or more initial related resources. Further, a single selection of the related content interface notification, via a user input device of the client device, causes details of at least one or more additional related resources to be rendered atop the Internet resource.

In some implementations, the plurality of attributes further include one or more related content attributes that are based on one or more related Internet resources that are linked-to in the related content notification for the Internet resource, or that are rendered in response to selection of the related content notification.

In some implementations, the method further includes determining one or more interaction properties of any user interaction, via the given client device, with the related content interface notification, and updating the machine learning model based on the one or more interaction properties.

In some versions of those implementations, updating the machine learning model includes reinforcement learning, and updating the machine learning model based on the one or more interaction properties includes determining a reward based on the one or more interaction properties, and updating the machine learning model based on the reward. In some further versions of those implementations, determining the reward includes selecting a first reward if the one or more interaction properties indicate interaction with the related content interface notification to view snippets of related resources that are related to the Internet resource, but indicates no user input to cause rendering of any of the related resources, and selecting a second reward if the one or more interaction properties indicate interaction with the related content interface notification to view snippets of related resources, and indicates user input to cause rendering of at least one of the related resources The second reward is more positive than the first reward. In some further versions of those implementations, determining the reward further includes selecting no reward, or a penalty, if the one or more interaction properties indicate no interaction with the related content interface notification, or selecting no reward, or a penalty, if the one or more interaction properties indicate dismissal of the related content interface notification.

In some versions of those implementations, updating the machine learning model comprises supervised learning. Further the predicted output indicates one or both of a predicted duration of access and a predicted extent of scrolling, the one or more interaction properties comprise one or both of an actual duration of access before interaction with the related content interface notification and an actual extent of scrolling before interaction with the related content interface notification, and updating the machine learning model based on the one or more interaction properties includes determining an error based on comparing the predicted output to the one or more interaction properties, and updating the machine learning model based on backpropogating the error across the machine learning model.

In some versions of those implementations, the method further includes, subsequent to updating the machine learning model, and updating the machine learning model based on additional rewards determined based on additional interaction properties of additional interactions with additional related content interfaces rendered for additional Internet resources: processing the plurality of attributes, using the machine learning model, to generate new predicted output, determining, based on the new predicted output, one or more new interaction conditions for triggering provision of the related content interface notification, and responsive to access of the Internet resource by an additional client device: causing the additional client device to render the related content interface notification in response to determining that the access of the Internet resource satisfies the one or more new interaction conditions.

In some implementations, a method implemented by one or more processors is provided and includes, determining a plurality of attributes for an Internet resource. The plurality of attributes includes one or more content attributes that are based on content of the Internet resource, and one or more navigation attributes indicating one or more particular attributes for navigating to the Internet resource. The method further includes determining, based on the plurality of attributes, one or more navigation attribute specific interaction conditions for triggering provision of a related content interface notification for the Internet resource. The method further includes, responsive to access of the Internet resource by a given client device, and responsive to determining that the access of the Internet resource by the given client device is a result of navigation that conforms to the one or more navigation attributes: causing the given client device to render the related content interface notification in response to determining that the access of the Internet resource satisfies the one or more navigation attribute specific interaction conditions.

These and other implementations of technology disclosed herein can optionally include one or more of the following features.

In some implementations, the one or more navigation attributes includes a path attribute that indicates a given navigational path, of a plurality of navigational paths, for accessing the Internet resource.

In some implementations, determining, based on the plurality of attributes, the one or more navigation specific interaction conditions includes processing the plurality of attributes, using a machine learning model, to generate a predicted output, and determining the one or more navigation specific interaction conditions based on the predicted output.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

1. A method implemented using one or more processors, the method comprising:
determining a plurality of attributes for an Internet resource, wherein the plurality of attributes comprise one or more content attributes that are based on content of the Internet resource;
processing the plurality of attributes, using a machine learning model, to generate predicted output;
determining, based on the predicted output, one or more interaction conditions for triggering provision of a related content interface notification for the Internet resource; and
responsive to access of the Internet resource by a given client device, and responsive to determining the one or more interaction conditions:
causing the given client device to render the related content interface notification in response to determining that the access of the Internet resource satisfies the one or more interaction conditions.

2. The method of claim 1, wherein the one or more content attributes comprise a type attribute that indicates a type, of a plurality of disparate types, to which the Internet resource most closely conforms.

3. The method of claim 1, wherein the one or more content attributes comprise a structural attribute, and wherein determining the structural attribute is based on an organizational structure of markup language of the Internet resource.

4. The method of claim 1, wherein the one or more content attributes comprise a lower-dimensional embedding of at least some of the content of the Internet resource, the lower-dimensional embedding is generated based on processing the at least some of the content using an additional machine learning model.

5. The method of claim 1,
wherein the plurality of attributes further comprise one or more navigation attributes indicating one or more particular attributes for navigating to the Internet resource.

6. The method of claim 5,
wherein determining, based on the predicted output, (a) to provide the related content interface notification for the Internet resource, and (b) the one or more interaction conditions for triggering provision of the related content interface notification, occur prior to access of the Internet resource by the given client device; and
wherein causing the given client device to render the related content interface notification in response to determining that the access of the Internet resource satisfies the one or more interaction conditions is further in response to determining that the access of the Internet resource by the given client device is a result of navigation that conforms to the one or more navigation attributes.

7. The method of claim 5, wherein the one or more navigation attributes comprise a path attribute that indicates a given navigational path, of a plurality of navigational paths, for accessing the Internet resource.

8. The method of claim 7, wherein the given navigational path is:
a query-based path that indicates accessing the Internet resource responsive to one or more search queries, or
a query-independent path that indicates accessing the Internet resource independent of any query.

9. The method of claim 8, wherein the given navigational path is the query-based path and indicates a breadth of the one or more search queries.

10. The method of claim 1, wherein the plurality of attributes further comprise one or more global historical interaction attributes that indicate measured past extents of past interactions, with previous related content interface notifications, responsive to previous renderings of the previous related content interface notifications for past accesses, by a plurality of client devices, of the Internet resource and/or of additional Internet resources determined to be similar to the Internet resource.

11. The method of claim 1, wherein the plurality of attributes further comprise one or more personal historical interaction attributes that indicate measured past extents of past interactions, by a user of the given client device, with previous related content interface notifications.

12. The method of claim 11, wherein the measured past extents of past interactions are with previous related content interface notifications for past accesses of additional Internet resources determined to be similar to the Internet resource.

13. The method of claim 1, wherein determining, based on the predicted output, the one or more interaction conditions for triggering provision of the related content interface notification, occurs prior to access of the Internet resource by the given client device.

14. (canceled)

15. The method of claim 1, wherein the one or more interaction conditions comprise a duration of the access of the Internet resource.

16. The method of claim 1, wherein the one or more interaction conditions comprise a scrolling condition that indicates whether, during access of the Internet resource, scrolling has occurred, an extent of the scrolling, a speed of the scrolling, or a direction of the scrolling.

17. The method of claim 1, wherein the one or more interaction conditions comprise at least two interaction conditions, and wherein access of the Internet resource satisfies the one or more interaction conditions only when each of the at least two interaction conditions are satisfied.

18-31. (canceled)

32. A method implemented using one or more processors, the method comprising:
determining a plurality of attributes for an Internet resource, wherein the plurality of attributes comprise:
one or more content attributes that are based on content of the Internet resource, and
one or more navigation attributes indicating one or more particular attributes for navigating to the Internet resource;
determining, based on the plurality of attributes, one or more navigation attribute specific interaction conditions for triggering provision of a related content interface notification for the Internet resource;
responsive to access of the Internet resource by a given client device, and responsive to determining that the access of the Internet resource by the given client device is a result of navigation that conforms to the one or more navigation attributes:
causing the given client device to render the related content interface notification in response to determining that the access of the Internet resource satisfies the one or more navigation attribute specific interaction conditions.

33. The method of claim 32, wherein the one or more navigation attributes comprise a path attribute that indicates a given navigational path, of a plurality of navigational paths, for accessing the Internet resource.

34. The method of claim 33, wherein determining, based on the plurality of attributes, the one or more navigation specific interaction conditions comprises:
processing the plurality of attributes, using a machine learning model, to generate a predicted output; and
determining the one or more navigation specific interaction conditions based on the predicted output.

35. (canceled)

36. (canceled)

37. A system comprising:
one or more processors; and
memory storing instructions that, when executed, cause the one or more processors to perform operations, the operations comprising:
determining a plurality of attributes for an Internet resource, wherein the plurality of attributes comprise one or more content attributes that are based on content of the Internet resource;
processing the plurality of attributes, using a machine learning model, to generate predicted output;
determining, based on the predicted output, one or more interaction conditions for triggering provision of a related content interface notification for the Internet resource; and
responsive to access of the Internet resource by a given client device, and responsive to determining the one or more interaction conditions:
causing the given client device to render the related content interface notification in response to determining that the access of the Internet resource satisfies the one or more interaction conditions.
